(19) United States
(12) Patent Application Publication
(10) Pub. No.: US 2025/0185085 A1
(43) Pub. Date: Jun. 5, 2025

(54) TECHNIQUES FOR ON-PREMISE WIRELESS WIDE AREA ACCESS CONNECTIVITY EQUIPMENT SHARING IN MULTI-TENANT ENVIRONMENTS

(71) Applicant: Cisco Technology, Inc., San Jose, CA (US)

(72) Inventors: Srinath Gundavelli, San Jose, CA (US); Vimal Srivastava, Bangalore, Karnataka (IN); Ravi Kiran Guntupalli, Cumming, GA (US); Pradeep K. Kathail, Los Altos, CA (US)

(21) Appl. No.: 18/529,091

(22) Filed: Dec. 5, 2023

(51) Int. Cl. H04W 76/12; H04L 12/46; H04W 84/12; H04W 88/16

(52) U.S. Cl. CPC H04W 76/12; H04L 12/4633; H04W 84/12; H04W 88/16

(57) ABSTRACT

Provided herein are techniques to facilitate on-premise wireless wide area access network equipment sharing in a multi-tenant environment. In one example, a method may include establishing a first wireline tunnel between a first wireless local area network (WLAN) access point (AP) of a first tenant and a gateway, the gateway being capable of a wireless wide area network (WWAN) connection with a mobile core network; establishing a second wireline tunnel between a second WLAN AP of a second tenant and the gateway; and upon a first wireless device connecting to the first WLAN AP of the first tenant, causing, by the gateway, establishment of a first WWAN protocol data unit (PDU) session for the first tenant with the mobile core network for communications involving the first wireless device and the mobile core network, wherein the first WWAN PDU session is associated with an identifier for the first tenant.

### TECHNICAL FIELD

The present disclosure relates to network equipment and services.

### BACKGROUND

Networking architectures have grown increasingly complex in communications environments, particularly mobile networking environments. Mobile communication networks have grown substantially as end users become increasingly connected to mobile network environments. In particular, there is a desire to provide wireless network connectivity in different environments, such as public venue environments. However, it can be difficult and costly to provide seamless coverage for wireless wide area access networks, such as Third Generation Partnership Project (3GPP) Fifth Generation (5G) networks, in many public venue environments. Thus, new opportunities are presented for providing wireless connectivity for wireless devices in such environments.

### BRIEF DESCRIPTION OF THE DRAWINGS

FIG. 1 illustrates a system in which on-premise wireless wide area access network equipment sharing may be provided for a multi-tenant environment, according to an example embodiment.

FIGS. 2A, 2B, 2C, 2D, 2E, 2F, 2G, and 2H are a message sequence diagram illustrating various example operations that may be performed to facilitate on-premise wireless wide area access network equipment sharing in a multi-tenant environment, according to an example embodiment.

FIGS. 3A, 3B, 3C, 3D, 3E, and 3F are a message sequence diagram illustrating various example operations that may be performed to facilitate on-premise wireless wide area access network equipment sharing in a multi-tenant environment, according to an example embodiment.

FIG. 4 illustrates another system in which on-premise wireless wide area access network equipment sharing may be provided for a multi-tenant environment, according to an example embodiment.

FIG. 5 is a flow chart depicting a method according to an example embodiment.

FIG. 6 illustrates a hardware block diagram of a computing device configured to perform functions associated with operations discussed in connection with embodiments herein.

### DETAILED DESCRIPTION

### Overview

Provided herein are techniques to facilitate on-premise wireless wide area access network equipment sharing in a multi-tenant environment. In accordance with embodiments herein, a system may provide internet services to each of multiple wired tenants over a shared 5G customer premise equipment (CPE) device, broadly referred to herein as a shared wireless wide area network (WWAN) on-premise device, shared WWAN gateway device, shared WWAN gateway, or any variations thereof. In some embodiments, the WWAN gateway may support multi-operator connectivity with multiple WWAN modems and eSIM profiles such that each tenant sharing the WWAN on-premise device may have the ability to choose a specific subscription package, services, and be responsible for service charges for WWAN connectivity/services (e.g., cellular/5G connectivity/services) provided by the WWAN gateway for each tenant's use of the device.

In at least one embodiment, a computer-implemented method is provided that may facilitate on-premise wireless wide area access network equipment sharing in a multi-tenant environment. In at least one embodiment, a computer-implemented method is provided that may include establishing a first wireline tunnel between a first wireless local area network (WLAN) access point (AP) of a first tenant and a gateway (e.g., WWAN gateway 104/404), the gateway being capable of a wireless wide area network (WWAN) connection with a mobile core network; establishing a second wireline tunnel between a second WLAN AP of a second tenant and the gateway in which the first tenant and the second tenant are different tenants; and upon a first wireless device connecting to the first WLAN AP of the first tenant, causing, by the gateway, establishment of a first WWAN protocol data unit (PDU) session for the first tenant with the mobile core network for communications involving the first wireless device and the mobile core network, wherein the first WWAN PDU session is associated with an identifier for the first tenant.

In at least one embodiment, the method may further include, upon a second wireless device connecting to the second WLAN AP of the second tenant, causing, by the gateway, establishment of a second WWAN PDU session for the second tenant for communications involving the second wireless device in which the second WWAN PDU session is associated with a second identifier for the second tenant and the second WWAN PDU session is different than the first WWAN PDU session.

In at least one embodiment, the method may include obtaining, by the gateway through establishment of the first WWAN PDU session, an Internet Protocol version 6 (IPv6) prefix, apportioning a first subset of IP addresses for the IPV6 prefix to the first tenant; upon a second wireless device connecting to the second WLAN AP of the second tenant, causing, by the gateway, apportioning a second subset of IP addresses for the IPV6 prefix to the second tenant; facilitating first data plane communications involving the first wireless device for the first WWAN PDU session in which the first wireless device is associated with a first IP address of the first subset of IP addresses, facilitating second data plane communications involving the second wireless device for the first WWAN PDU session in which the second wireless device is associated with a second IP address of the second subset of IP addresses.

### Example Embodiments

Mobile network operators are exploring new service offering opportunities leveraging wireless wide area (WWA) accesses, such as Third Generation Partnership Project (3GPP) Fifth Generation (5G) access or, more broadly 3GPP cellular access. In a large public venue (LPV) environment, such as in a mall or shopping center, as an example only, a 5G-capable router can be provided as a customer premise equipment (CPE), more generally referred to herein as ‘on-premise’ equipment, in which such a wireless wide area network (WWAN) router or gateway may be considered a starting point for extending broadband connectivity services (e.g., wired broadband connectivity) to retail and enterprise network segments and may also facilitate wireless connectivity to a WWAN of a mobile network operator (MNO), such as a 3GPP 5G radio access network (RAN) that interfaces with a mobile core network operated by the MNO.

However, in many public venue environments, such as shopping malls and multi-floor structures that include multiple tenants, deployment of dedicated a 5G WWAN device for every tenant is not an option. For example, some locations for such structures may have poor indoor Radio Frequency (RF) coverage to 5G cell towers. Further, the monetary expense of deploying a 5G CPE device for every tenant may be cost prohibitive. However, in many such LPV environments, there exists wired connectivity, such as Ethernet wiring, that interconnects each location (e.g., each retailer) to a central or centralized wiring closet or location, at which network routers, etc. can be provided.

Thus, there is a service creation opportunity for 5G wireless mobile network operators for extending connectivity services to tenants behind a 5G-capable CPE/on-premise device in combination with wireless local area network (WLAN) (e.g., Wi-Fi®) and wired termination devices. Service creation opportunities may also be provided for wired ser Potential relevance to wired service providers as well.

In accordance with embodiments herein, techniques are provided that may facilitate on-premise wireless wide area access network equipment sharing in a multi-tenant environment.

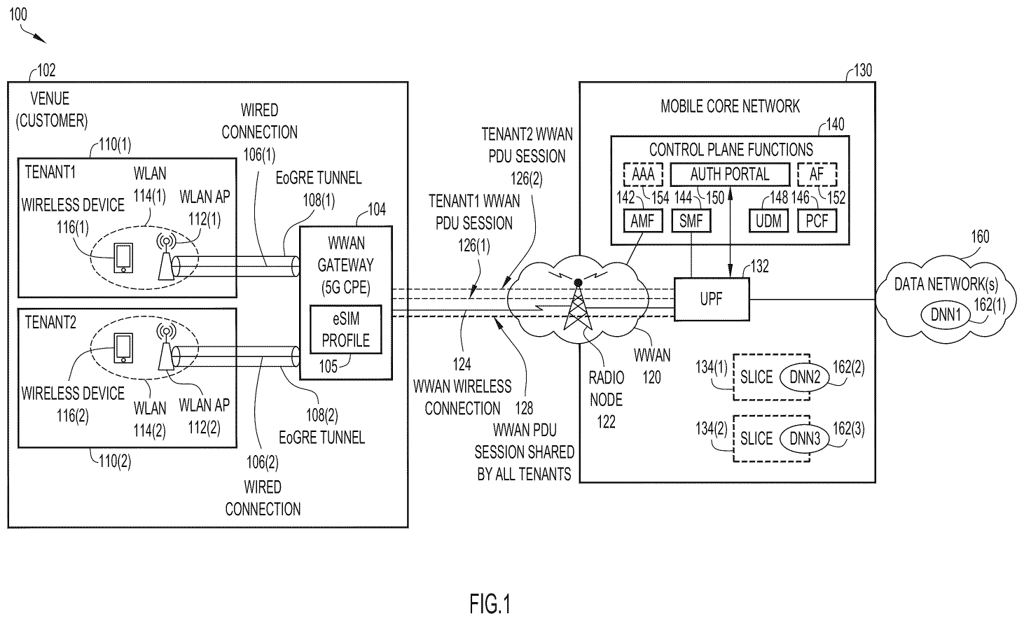

Referring to FIG. 1, FIG. 1 illustrates a system 100 in which wide area access network equipment sharing may be provided for a multi-tenant environment, according to an example embodiment. In at least one embodiment, system 100 may include a venue 102, such as a LPV (e.g., a mall, office complex, etc.), a wireless wide area network (WWAN) 120 including a radio node 122, and a mobile core network 130 operated by a service provider (SP), also sometimes referred to as a mobile network operator (MNO).

Also shown in FIG. 1 are one or more data networks 160, such as the public Internet, an enterprise/private network (e.g., a business entity, a government entity, an education entity, etc. to serve enterprise purposes), an Internet Protocol (IP) Multimedia Subsystem (IMS), an Ethernet network/switching system, and/or the like. In at least one embodiment, the Internet, an IMS, etc. may be associated with a data network name (DNN), such as DNN1 162(1), which can be identified for a protocol data unit (PDU) session to be established via mobile core network 130 for a WWAN/5G user equipment (UE), such as WWAN gateway 104, having a subscription/subscription data/information stored via mobile core network 130.

Venue 102 may include a number of physical tenant locations or spaces (e.g., stores, offices, floors, etc.) that can be utilized by each of a number of tenants, such as a location/space of a first tenant, Tenant1 110(1), and a location/space for a second tenant, Tenant2 110(2), in which each respective tenant may operate a respective wireless local area network (WLAN) to provide wireless connectivity for wireless devices that may be present at each tenant location/space. Venue 102 may further include a 3GPP 5G/cellular/WWAN CPE/gateway, shown in FIG. 1 as WWAN gateway 104 in which the WWAN gateway may include any combination of hardware, software, logic, and/or the like to facilitate wired connectivity (e.g., via wired wide area network (WAN) ports/hardware/software/logic) with WLAN equipment operated by one or more tenants of venue 102, such as Tenant1 110(1) and Tenant2 110(2), and may also facilitate wireless (e.g., Radio Frequency (RF)) 5G/cellular connectivity with WWAN 120/radio node 122.

For example, Tenant1 110(1) may operate a WLAN access point (AP) 112(1) that provides a WLAN coverage area for a WLAN 114(1) (e.g., represented via the dashed-line ellipse, which may be representative of any Wi-Fi®/Institute of Electrical and Electronics Engineers (IEEE) 802.11 WLAN) that may serve any number of wireless devices at the location/space of Tenant1 110(1), such as a wireless device 116(1). In another example, Tenant2 110(2) may operate a WLAN access point (AP) 112(2) that provides a WLAN coverage area for a WLAN 114(2) (e.g., represented via the dashed-line ellipse, which may be representative of any Wi-Fi®/IEEE 802.11 WLAN) that may serve any number of wireless devices at the location/space of Tenant2 110(2), such as a wireless device 116(2).

As shown in FIG. 1, WLAN AP 112(1) operated by Tenant1 110(1) interfaces with WWAN gateway 104 via a wired connection 106(1), which may be an Ethernet-based wired connection in at least one embodiment. Further, WLAN AP 112(2) operated by Tenant2 110(2) interfaces with WWAN gateway 104 via a wired connection 106(2), which may also be an Ethernet-base wire connection in at least one embodiment. It is to be understood that any number of networking devices (e.g., routers, switches, etc.) may be present in system 100 to facilitate wired connectivity between WWAN gateway 104 and each of WLAN AP 112(1) and WLAN AP 112(2), such that each WLAN AP may not be directly interconnected with the WWAN gateway 104. Further, although not shown in FIG. 1, in some embodiments, one or more of WLAN AP 112(1) and/or WLAN AP 112(2) may be operated in conjunction with one or more wireless LAN controllers (WLCs) operated by each tenant and/or an operator operating network(s) for venue 102.

Regarding mobile core network 130, mobile core network 130 may include any number of physical and/or virtualized network functions (VNFs), such as a user plane function (UPF) 132 and a number of control plane (CP) functions 140, such as an Access and Mobility Management Function (AMF) 142, a Session Management Function (SMF) 144, a Policy Control Function (PCF) 146, a Unified Data Management (UDM) entity, shown in FIG. 1 as UDM 148, and an authorization/authentication portal function, referred to herein as ‘auth’ portal 150. In some instances, auth portal 150 may be provided via data networks 160. In some embodiments, CP functions 140 may include an Authentication, Authorization, and Accounting (AAA) server or service, shown in FIG. 1 as AAA 154, and/or an Application Function (AF) 152. UDM 148 can interface with and/or be implemented in combination with a Unified Data Repository (UDR) (not shown in FIG. 1.

In some embodiments, one or more network slices, such as a network slice 134(1) associated with a DNN2 162(2) and a network slice 134(2) associated with a DNN3 162(3) may be provided by mobile core network 130. A network slice is a logical end-to-end network, often instantiated via a combination of slice resources, such as VNFs, in which the network slice can be dynamically created (instantiated) and may include any combination of 3GPP mobile core network functions/functionality. Thus, a network slice can generally refer to a group or set of slice resources that are configured and instantiated in order to facilitate mobile network services. Various example network slice types can include, but not be limited to, a cellular vehicle to everything (V2X) network slice type that can provide cellular V2X services, a massive IoT (mIoT) network slice type that can provide IoT related services, an Ultra-Reliable Low-Latency Communication (URLLC) network slice type that can provide URLLC services, an enhanced Mobile Broadband (cMBB) network slice type that can provide mobile broadband services, a massive Machine-Type Communication (mMTC) network slice type that can provide MTC services, a High Performance Machine-Type Communication (HMTC) network slice type that can provide HMTC services, etc. Other slice types can be configured/instantiated by a mobile network operator that may or may not conform to standards-based network slice types.

Generally, for mobile core network 130, the CP functions 140 may interface with each other via a service-based interface (SBI) or any other appropriate interface. Further, SMF 144 may interface with UPF 132 (e.g., via a 3GPP N4 interface), in which UPF 132 which may also interface with radio node 122 of WWAN 120 (e.g., via a 3GPP N3 interface), with data networks 160 (e.g., via 3GPP N6 interface(s)), as well as auth portal 150 (which, in some embodiments, may be included within a given data network). AMF 142 may also interface with radio node 122 of WWAN (e.g., via a 3GPP N2 interface). Any of CP functions 140 may also interface with any VNFs of network slices 134(1) and/or 134(2) in accordance with any 3GPP standards, such as 3GPP Technical Specification (TS) 23.501, 23.502, etc.

In accordance with embodiments herein, WWAN gateway 104, in addition to wired connections 106(1) and 106(2) with each WLAN AP 112(1) and WLAN AP 112(2), can also facilitate one or more WWAN wireless connections with radio node 122 of WWAN 120, such as a WWAN wireless connection 124, as shown in FIG. 1. Thus, for WWAN connections facilitated by a WWAN gateway, such as WWAN gateway 104, in accordance with embodiments herein, the WWAN gateway may be characterized as a WWAN/5G UE such that the WWAN gateway 104 can be configured with WWAN/5G wireless hardware, software, logic, etc. (e.g., baseband processor(s), modem(s), RF transceiver(s), antenna(s), etc.) and at least one WWAN/5G subscription profile, such as an electronic Subscriber Identity Module (eSIM) eSIM profile 105, can be provisioned for the WWAN gateway 104; for example, for an embedded Universal Integrated Circuit Card (eUICC) provided for the WWAN gateway 104 (not shown).

In various embodiments, a subscription profile provisioned for a WWAN gateway, such as for eSIM profile 105, can include a subscription/device identifier for the gateway/UE, such as an International Mobile Subscriber Identity (IMSI), Subscription Permanent Identifier (SUPI), and/or the like, along with any other appropriate subscription information/data (e.g., Integrated Circuit Card Identifier (ICCID), security algorithms, authentication/security key(s), etc. along with network identifier metadata that may include a Public Land Mobile Network (PLMN) Identifier PLMN ID, Network Identifier (NID), Access Point Name (APN) and/or DNN information, operating frequencies, etc., in accordance with 3GPP standards). For various example operations discussed herein with reference to system 100, consider that WWAN gateway 104 is provisioned with a SUPI corresponding to ‘SUPI=104’.

In some embodiments, a WWAN gateway can potentially support multi-operator connectivity (e.g., to facilitate connections with different 5G operators) via multiple WWAN/5G modems and subscription profiles (e.g., multiple eSIM profiles) that can be utilized to facilitate connections with different 5G accesses provided by different 5G MNOs/SPs (e.g., Operator 1, Operator 2, etc.).

Through embodiments of system 100, new service definitions can be enabled that facilitate providing internet services to wired tenants over a shared 5G on-premise device, such as shared WWAN gateway 104, that may facilitate both wired network connectivity to tenant locations/WLAN equipment and WWAN connectivity to one or more mobile core networks. In at least one embodiment, the shared WWAN gateway 104 can be centrally located and can serve multiple tenants for an environment, such as venue 102.

Broadly, in accordance with embodiments herein, a corresponding wireline tunnel, such as an Ethernet over General Routing Encapsulation (EoGRE) tunnel, can be established between each of a corresponding WLAN termination device of each of Tenant1 110(1) and Tenant2 110(2) and the WWAN gateway 104 during operation of system 100. For example, during operation of system 100, an EoGRE tunnel 108(1) can be established, via wired connection 106(1), between Tenant1's WLAN AP 114(1) and WWAN gateway 104 and an EoGRE tunnel 108(2) can be established, via wired connection 106(2), between Tenant2's WLAN AP 114(2) and WWAN gateway 104.

During operation of system 100, embodiments herein may facilitate authentication tenant wired/wireline connectivity with the WWAN gateway 104, via corresponding EoGRE tunnels 108(1) and 108(2) without involving any identity for 5G services (e.g., such as an eSIM profile or 5G wireless modem identity) to authenticate such wired connectivity between each WLAN AP 112(1) and 112(2) and the WWAN gateway 104. Various techniques may be utilized for EoGRE tunnel establishment in accordance with embodiments herein. For example, in some instances, a static configuration can be provided for each WLAN AP 112(1) and WLAN AP 112(2) including endpoint information for the WWAN gateway 104 (e.g., IP address, etc.) that can be utilized to initiate an exchange with the WWAN gateway 104 regarding EoGRE tunnel establishment using techniques as would be understood by a person of ordinary skill in the art. In another example, in some instances, each WLAN AP 112(1) and WLAN AP 112(2), upon bootup, can perform a Domain Name System (DNS) lookup on a standard Fully Qualified Domain Name (FQDN). For example, each WLAN AP 112(1) and WLAN AP 112(2), after bootup, can obtain an IP address through DHCP along realm information (e.g., venue102realm.com) from which each WLAN AP can formulate a DNS query (e.g., wwangateway103.venue102realm.com) and perform a DNS lookup in order to determine the IP address, etc. for the WWAN gateway 104 (the DNS can be configured with the FQDN so that the APs can formulate the query). Thereafter, the respective EoGRE tunnels for each WLAN AP 112(1) and WLAN AP 112(2) can be established using techniques as would be understood by a person of ordinary skill in the art.

The WWAN gateway 104 can store a unique identifier for tenant for each tenant with which a wireline tunnel is established in a mapping or other correlation table/database/data structure that identifies each corresponding tunnel in association with each tenant For example, a tenant identifier (T-ID) for Tenant1 110(1) can be set as ‘T-ID=1101’ and a T-ID for Tenant2 110(2) can be set as ‘T-ID=1102’ and WWAN gateway 104 can store in a table/database/data structure a tenant mapping that identifies each corresponding EoGRE tunnel in association with each tenant, such as: EoGRE tunnel 108(1)=T-ID (1101) and EoGRE tunnel 108(2)=T-ID (1102).

The tenant ID for each tenant for each respective EoGRE tunnel 108(1) and 108(2) can be sent to each respective WLAN AP 112(1) and 112(2), such that each WLAN AP can include its respective tenant ID in communications sent to WWAN gateway 104.

Different approaches for sharing the WWAN gateway 104 may be provided in accordance with embodiments herein. For a first approach, system 100 may facilitate establish a unique WWAN/5G PDU session for each tenant of the multiple tenants that may be sharing the WWAN gateway 104.

For example, in at least one embodiment, a WWAN PDU session 124(1) can be established by WWAN gateway 104 with mobile core network 130 (via UPF 132, for example) for use by Tenant1 110(1) or, more specially, for any number of wireless devices connected to WLAN AP 112(1) for which data plane communications can be provided via WWAN PDU session 124(1) to any combination of data network(s) 160 and/or network slices 134(1)/134(2) via mobile core network 130. Although only one wireless device 116(1) is shown in system 100 for Tenant1, it is to be understood that multiple wireless devices connected to WLAN AP 112(1) can all be served via the same WWAN PDU session 124(1) established for Tenant1 110(1) by WWAN gateway 104.

Further for the first approach, in at least one embodiment, a separate WWAN PDU session 124(2) can be established by WWAN gateway 104 with mobile core network 130 (via UPF 132, for example) for use by Tenant2 110(2) or, more specially, for any number of wireless devices connected to WLAN AP 112(2) for which data plane communications can be provided via WWAN PDU session 124(2) to any combination of data network(s) 160 and/or network slices 134(1)/134(2) via mobile core network 130. Similar to Tenant1, although only one wireless device 116(2) is shown in system 100 for Tenant2, it is to be understood that multiple wireless devices connected to WLAN AP 112(2) can all be served via the same WWAN PDU session 124(2) established for Tenant1 110(2) by WWAN gateway 104.

For a second approach, system 100 may facilitate a single WWAN/5G PDU session that can serve multiple tenants that may be sharing the WWAN gateway 104. In at least one embodiment, a WWAN PDU session 128 can be established by WWAN gateway 104 with mobile core network (via UPF 132, for example) for use by both of Tenant1 110(1) and Tenant2 110(2) for any number of wireless devices that may be connected to WLAN AP 112(1) and/or WLAN AP 112(2) for which data plane communications can be provided via WWAN PDU session 128 to any combination of data network(s) 160 and/or network slices 134(1)/134(2) via mobile core network 130.

Thus, embodiments herein may encompass different approaches for facilitating PDU session connectivity between a shared WWAN gateway and one or more mobile core networks for any combination of tenants that may be sharing service provided by the WWAN gateway.

In some embodiments, a tenant mapping stored by WWAN gateway 104 can utilize an IP version 6 (IPv6) prefix allocated to a given tenant by the mobile core network (e.g., by SMF 144) for a PDU session involving the given tenant such that the tenant mapping can identify a given wireline (EoGRE) tunnel for the given tenant based on the IPV6 prefix in addition to and/or in lieu of the tenant identifier assigned to the given tenant. By way of example only, an IPV6 prefix (network address and subnet) of ‘2001:00BC:AB00:1101::0/64’ (or any appropriate subnetwork range) can be allocated to Tenant1 110(1) for a given PDU session involving Tenant1 110(1) in which wireless devices, such as wireless device 116(1) can be allocated an IP address from the IPv6 prefix range or block for use of the PDU session. In another example, an IPV6 prefix of ‘2001:00BC:AB00:1102::0/64’ can be allocated to Tenant2 110(2) for a given PDU session involving Tenant1 110(1) in which wireless devices, such as wireless device 116(2) can be allocated an IP address from the IPV6 prefix range or block for use of the PDU session.

In some embodiments, different subnetwork ranges or subsets/pools of IP addresses for a given IPv6 prefix can be allocated to different tenants; for example, if multiple tenants share the same PDU session (e.g., an address range of 10.10.1.0 to 10.10.1.50, or prefix 10.10.1.0/24, or in IPV6 CAFE::/64 or BABA::/48, and/or any variations thereof).

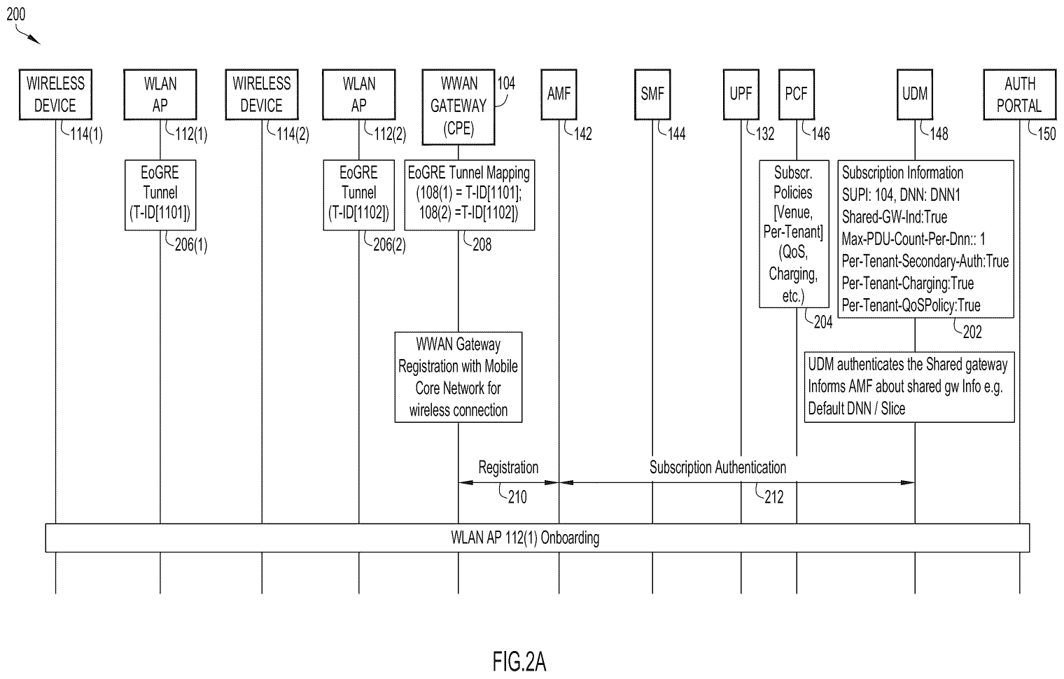

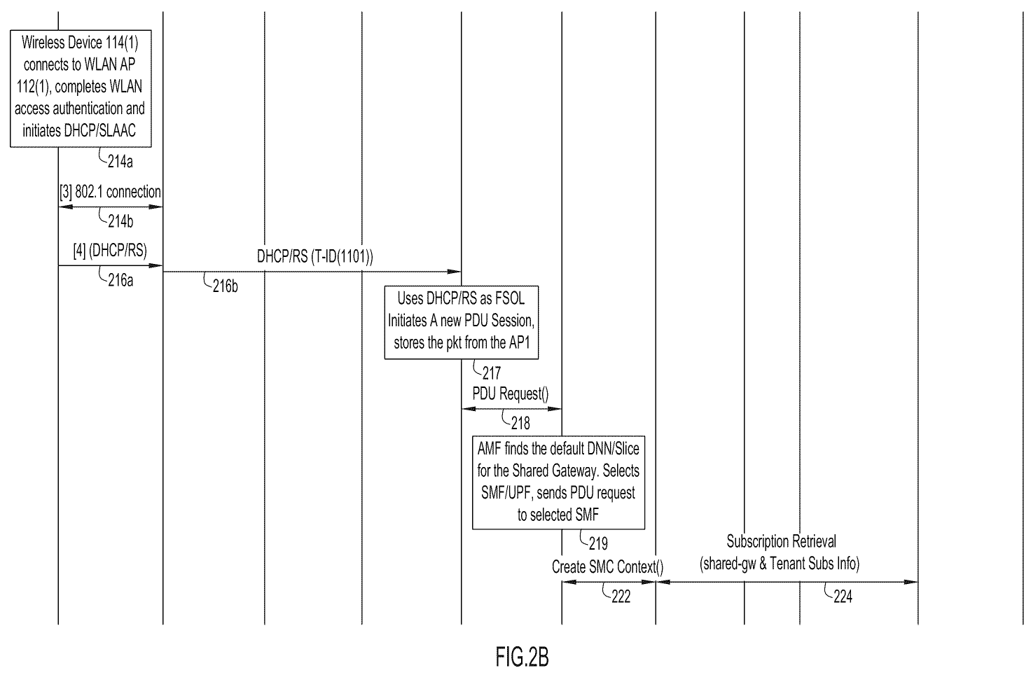

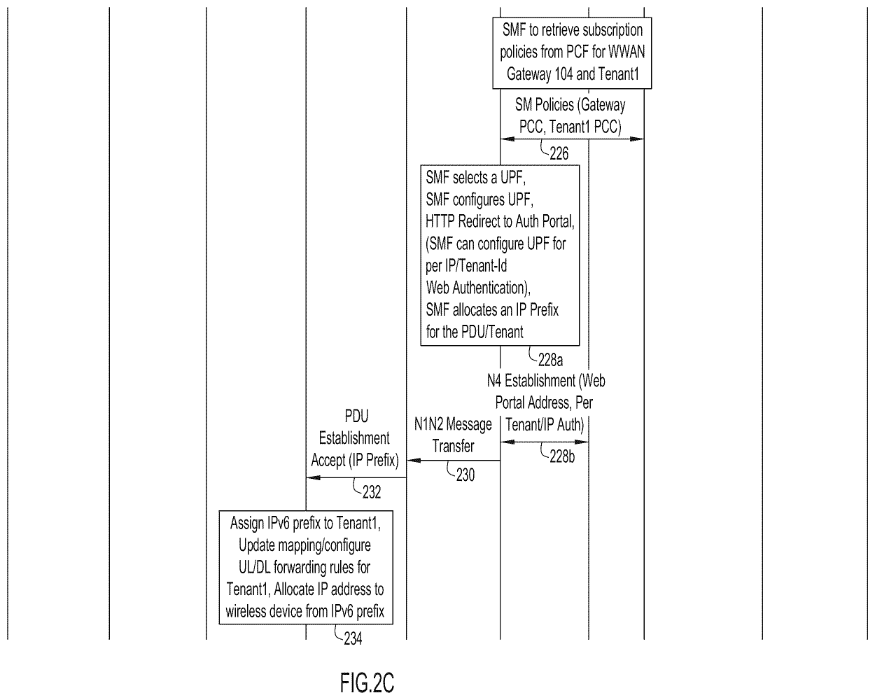

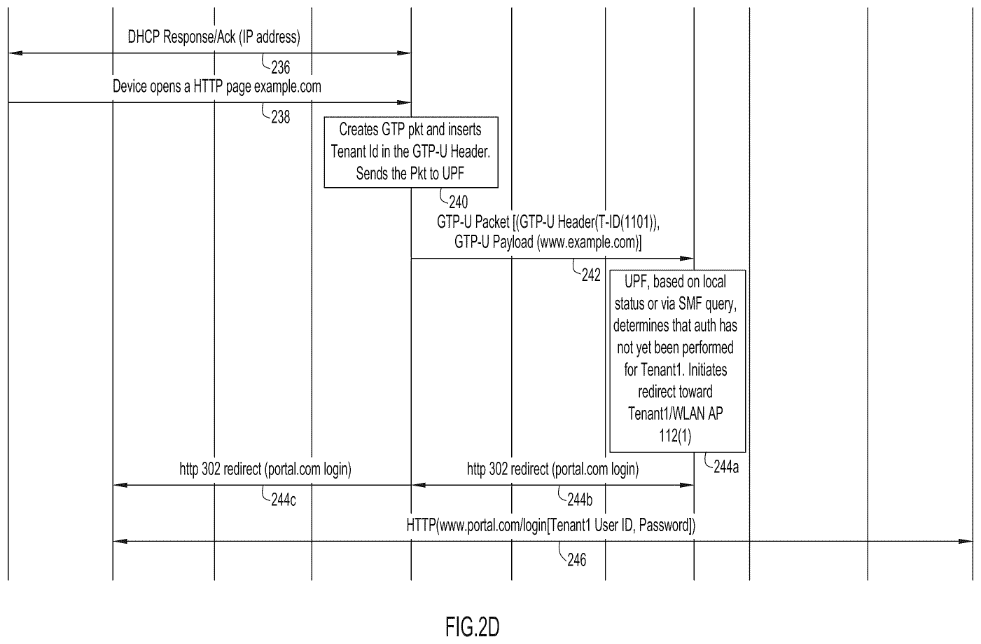

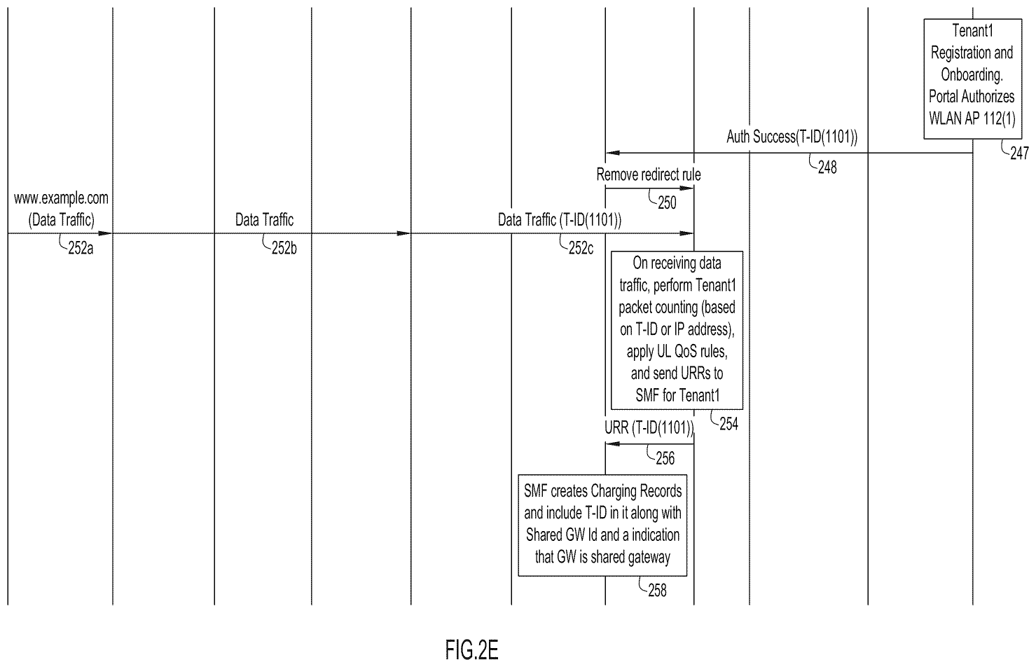

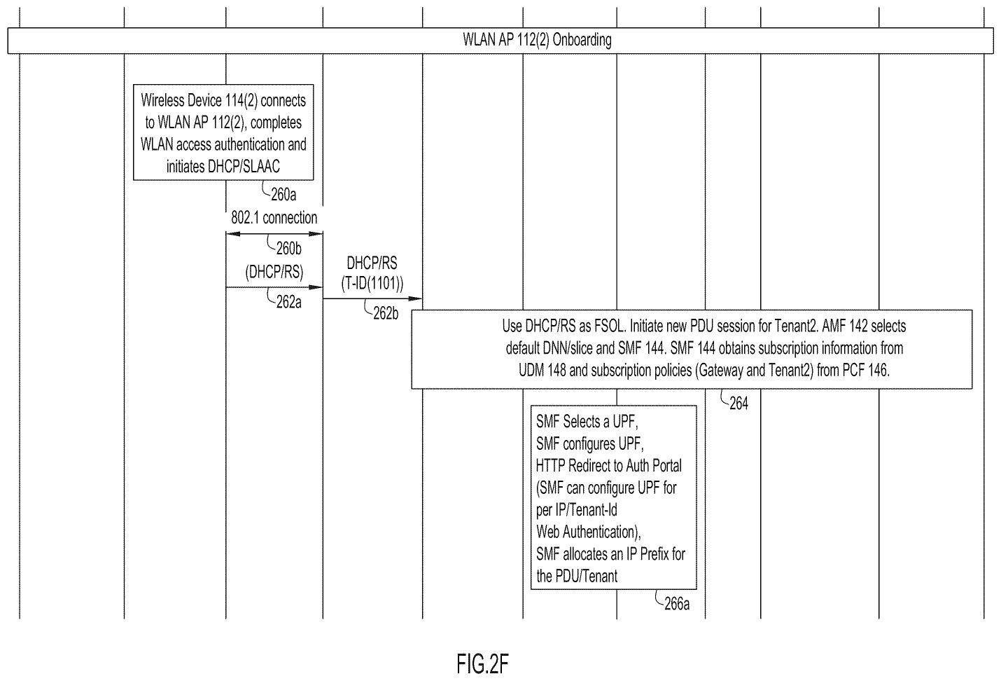

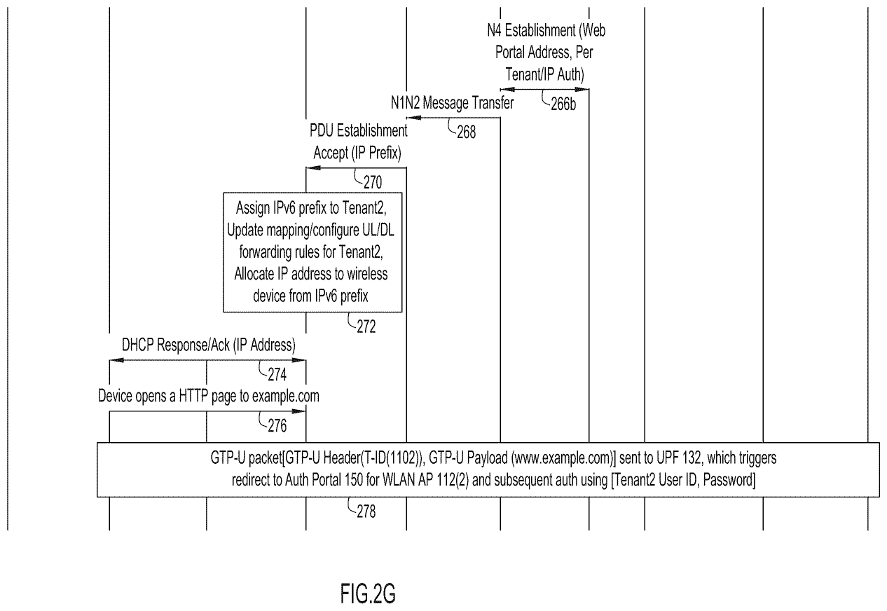

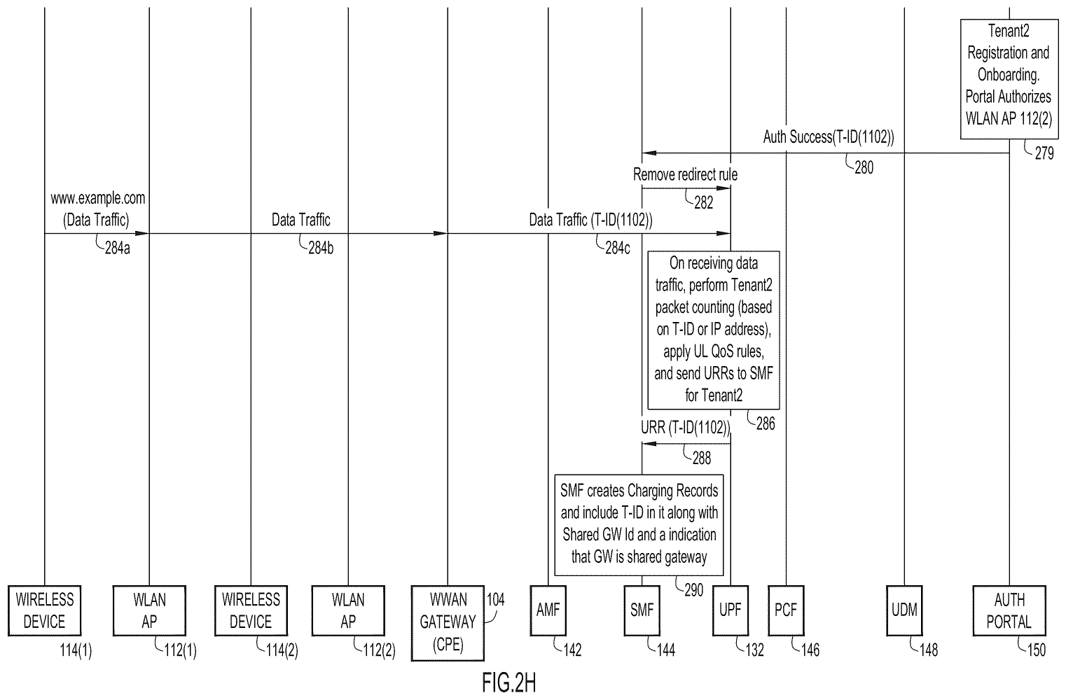

Embodiments herein can enable tenants with the ability to choose a specific subscription package, services, and be responsible for the service charges for wireless devices that utilize 5G connectivity via each corresponding tenant. Through operation of system 100, as discussed in more detail with reference to FIGS. 2A-2H, discussed below, embodiments herein may also enable on-boarding of tenants for utilizing WWAN/5G connectivity using registration and activation operations, such as web-based registration and service activation that can be facilitated via auth portal 150.

Further, embodiments of system 100 may enable differentiated service levels (e.g., network slice differentiation, Quality of Service (QOS) differentiation, Service-Level Agreement (SLA) differentiation, etc.) based on the subscription levels that may be utilized by each of multiple tenants that may utilize the WWAN gateway 104 for WWAN/5G wireless network connectivity.

As one billing record generated only on the basis of the WWAN gateway 104 itself for WWAN PDU session(s) triggered by WWAN gateway 104 for establishment with mobile core network 130 not be sufficient to appropriately determine the charging incurred by each tenant's use of the WWAN gateway 104, system 100 may provide for the ability to generate per-tenant charging records for each tenant that may utilize the WWAN gateway 104 for WWAN/5G wireless network connectivity.

For example, during operation of system 100, WWAN gateway 104 can utilize the tenant mapping information (e.g., T-ID and/or IPv6 prefix) in order to identify data packet(s) sent to mobile core network 130 for a given WWAN PDU session such that the tenant mapping information can be used to identify data packets for data plane communication that are to be charged to/billed to a particular tenant.

In at least one embodiment, for data plane communications involving a given wireless device connected to a particular WLAN AP for a particular tenant (for which a WWAN PDU session is provided with a mobile core network by the WWAN gateway), a T-ID for the particular tenant can be included by the WWAN gateway 104 in a General Packet Radio Service (GPRS) Tunneling Protocol (GTP) user-plane (GTP-U) header for GTP-U packets sent to the mobile core network; for example, to UPF 132. Using the T-ID included in the GTP-U header(s) of such packets, the UPF 132 can generate Usage Report Record(s) URR(s) including charging information for the particular tenant that can be sent to the SMF 144 that can generate charging data records (CDR(s)) including the T-ID that can be sent to a charging system/function (not shown) that can generate billing/invoices for the particular tenant.

In some embodiments, IPv6 prefix information and/or subnet information of an IPV6 prefix associated with a particular tenant can be used by the UPF 132 to generate URR(s) in addition to and/or in lieu of using T-ID information.

Consider various example operations that can be performed via system 100 as shown via FIGS. 2A, 2B, 2C, 2D, 2E, 2F, 2G, and 2H which are a message sequence diagram 200 illustrating various example operations that may be performed to facilitate on-premise wireless wide area access network equipment sharing in a multi-tenant environment, according to an example embodiment. The example embodiments of FIGS. 2A-2H illustrates example operations associated with the first approach in which a unique WWAN/5G PDU session is provided for each of Tenant1 110(1) and Tenant2 110(2) that sharing the WWAN gateway 104 for WWAN connectivity with mobile core network.

FIGS. 2A-2H include wireless device 114(1) and WLAN AP 112(1) associated with Tenant1 110(1) location, wireless device 114(2) and WLAN AP 112(2) associated with Tenant2 110(2) location, WWAN gateway 104 (including eSIM profile 105). Also shown in FIGS. 2A-2H arc AMF 142, SMF 144, UPF 132, PCF 146, UDM 148, and auth portal 150 of mobile core network 130. WWAN 120 including radio node 122 is not shown in FIGS. 2A-2H for purposes of brevity only; however, it is to be understood that WWAN gateway 104 can connect to/interface with any elements/functions of mobile core network 130 via a corresponding wireless connection with the WWAN 120/radio node 122 in order to facilitate various operations discussed herein.

As shown at 202, consider that various subscription information for one or more UE of system 100, such as for WWAN gateway 104, can be configured for UDM 148. In at least one embodiment, the subscription information configured at 202 for WWAN gateway 104 can include a subscription identifier for WWAN gateway 104, such as the SUPI provided for the WWAN gateway 104 (e.g., SUPI=104) and a default DNN for PDU session(s) that can be established for the WWAN gateway 104, such as identifying DNN1 162(1) (e.g., Internet).

In at least one embodiment, the subscription information configured for WWAN gateway 104 at UDM 148 can include an indication, flag, or other identifier that indicates that that WWAN gateway 104 is a shared gateway (e.g., ‘Shared-GW: True’) in which such an indication can be used to trigger enhanced functionality within mobile core network 130 for elements involved in PDU session(s) associated with the shared gateway, such as triggering enhanced PDU session establishment operations, triggering the configuring of redirect rules for a UPF for secondary authentication procedures (if further identified in subscription information for the shared WWAN gateway), triggering enhanced billing for the PDU session(s) involving the WWAN gateway 104, etc.

Further, the subscription information configured for WWAN gateway 104 at 202 in at least one embodiment can include an indication of the maximum number of PDU sessions per tenant that can be established by the WWAN gateway. For the embodiments of FIGS. 2A-2H, consider that the indication of the maximum number of PDU sessions per tenant configured for WWAN gateway is set to 1 (e.g., ‘Max-PDU-Count-Per-Dnn=1). For the embodiments of FIGS. 2A-2H, recall that each of Tenant1 110(1) and Tenant2 110(2) may have their own respective PDU session established for data plane communications. In some instances, if the maximum number of PDU sessions is more than 1, each tenant may be allocated multiple sessions.

Further, the subscription information configured for WWAN gateway 104 at 202 in at least one embodiment can include an indication, flag, or other identifier that indicates that per-tenant-secondary authentication is enabled for the WWAN gateway 104 (e.g., ‘Per-Tenant-Secondary-Auth: True’) such that, for each tenant for which data plane communications/PDU session establishment is triggered, a secondary authentication process is to be utilized via auth portal 150 in order to authenticate/authorize IP data plane communications for the particular tenant.

Further, the subscription information configured for WWAN gateway 104 at 202 in at least one embodiment can include an indication, flag, or other identifier that indicates that per-tenant charging is enabled for the WWAN gateway 104 (e.g., ‘Per-Tenant-Charging: True’) such that, for each tenant for which data plane communications/PDU session establishment is triggered (and successfully authenticated/authorized), per-tenant charging information is to be generated for data plane communications involving each tenant. Specifically, such charging subscription information can be used to initiate/trigger per-tenant charging information to be generated for each particular tenant for each of multiple potential wireless devices for which data plane communications can be handled for each particular tenant (via separate PDU sessions or via a shared PDU session) for mobile core network 130, such as via UPF 132 and SMF 144 or a via corresponding UPF/SMF provided for network slices 134(1)/134(2), if applicable.

Per-tenant charging information that can be generated by a UPF, such as UPF 132, can include per-tenant URRs in which each URR generated for a particular tenant can include the particular tenant ID (T-ID) for the particular tenant. Further, per-tenant charging information that can be generated by an SMF, such a SMF 144, can include per-tenant CDRs based on per-tenant URRs received from a UPF, in which each CDR generated for a particular tenant can include the particular tenant ID (T-ID) for the particular tenant, which can further be sent to a charging system for billing the particular tenant appropriately.

Further, the subscription information configured for WWAN gateway 104 at 202 in at least one embodiment can include an indication, flag, or other identifier that indicates that per-tenant QoS differentiation is to be provided for data plane communications/PDU sessions involving each tenant (e.g., ‘Per-Tenant-QoSPolicy: True’) based on a corresponding QoS policy for each tenant. Such QoS differentiation, as provided for a particular QoS policy for a particular tenant, can be provided for data plane communications that can be handled for each particular tenant (via separate PDU sessions or via a shared PDU session) for mobile core network 130, such as via UPF 132 or a via corresponding UPF provided for network slices 134(1)/134(2), if applicable.

As shown at 204, subscription policy information, typically referred to as Policy and Charging Control (PCC) rules/information, can be configured/provisioned at PCF 146 for WWAN gateway 104 and/or the venue 102 (e.g., venue provider) in which the WWAN gateway 104 that is to be shared by multiple tenants is implemented/provided. Such WWAN gateway/venue subscription policy information can include, but not be limited to, QoS policies contracted by the venue provider for mobile core network services, charging information to be applied to the venue provider, and/or the like.

In some embodiments, if per-tenant QoS policies are enabled per the subscription information provided for the WWAN gateway 104 at 202 (e.g., Per-Tenant-QoSPolicy: True), then the subscription policy information configured for PCF 146 at 204 can further include per-tenant QoS policy information and/or charging information (e.g., per-tenant PCC information).

Operations for the example embodiments of FIGS. 2A-2H can include, as generally shown at 206(1) and 206(2), each of WLAN AP 112(1) for Tenant1 110(1) location and WLAN AP 112(2) for Tenant2 110(2) location performing an auto-discovery process with the WWAN gateway 104 and setting up, via corresponding wired connections (106(1) and 106(2)) with the WWAN gateway 104, a corresponding dedicated EoGRE tunnel with the WWAN gateway 104, such as EoGRE tunnel 108(1) for WLAN AP 112(1) and EoGRE tunnel 108(2) for WLAN AP 112(2). The WWAN gateway 104 can assign a tenant ID to each of Tenant1, such as ‘T-ID=1101’, and Tenant2, such as ‘T-ID=1102’. Each corresponding assigned tenant ID can be provided to each corresponding WLAN AP 112(1) and WLAN AP 112(2) for use with various operations/communications involving each corresponding EoGRE tunnel 108(1) and EoGRE tunnel 108(2).

As shown at 208, the WWAN gateway 104 maintains tunnel mapping information, such a per-tenant tunnel/tenant ID mapping (e.g., EoGRE tunnel 108(1)=T-ID (1101), EoGRE tunnel 108(2)=T-ID (1102)). The WWAN gateway 104 can update the tunnel mapping information with additional per-tenant information, such as IP prefix information, PDU session identifier information, etc. for additional operations provided by WWAN gateway 104 through operations discussed for embodiments herein.

In at least one embodiment, tenant IDs assigned by WWAN gateway 104 to tenants/tunnels for a given venue, such as venue 102, can formatted, agreed upon, or otherwise predefined/preconfigured according to subscription information, policies, etc. provided and/or exchanged between the venue provider and the MNO/SP for a given mobile core network, such as mobile core network 130, with which the venue provider/WWAN gateway 104 has a subscription for services so that the tenant IDs assigned by the WWAN gateway for corresponding tenant tunnels can also be appropriately utilized for various operations provided via the mobile core network (e.g., policy information look-up, QoS handling, charging information generation, etc.). For example, in at least one embodiment, tenants for a given venue, such as venue 102, can contract with an MNO/SP that is to provide WWAN connectivity for the venue such that tenant IDs for each tenant can effectively ‘subscribe’ for different levels of service (e.g., different subscription classes, such as gold, silver, bronze, etc., each with different QoS levels, etc.) that can be provided through a shared WWAN gateway/CPE provided for the venue. In another embodiment, tenant IDs may be preconfigured at a WWAN gateway and signaled to a mobile core network and the core network can ensure that the tenant IDs received from the WWAN gateway will be utilized/associated with any tenant specific traffic handled via the core network.

Following tunnel establishment, tenant ID assignment, and mapping operations, WWAN gateway 104 can perform a registration process with the mobile core network 130 in order to establish WWAN/5G wireless connectivity between WWAN gateway 104 and mobile core network 130. For example, as shown at 210, WWAN gateway 104 initiates a mobile network registration with AMF 142 (via WWAN 120/radio node 122), which triggers AMF 142 to obtain subscription information and perform an authentication process to authenticate/authorize WWAN gateway 104 to connect to mobile core network 130 through subscription information obtained for WWAN gateway 104 from UDM 148, as shown at 212. Such operations at 210 and 212 can include standards-based authentication/authorization operations performed based on the eSIM profile 105 provided for WWAN gateway 104 involving the SUPI for the gateway.

Although successful authentication of WWAN gateway 104 may authorize the WWAN gateway 104 to establish PDU session(s) with the mobile core network 130, per-tenant secondary authentication is to be additionally performed, for example, based on the subscription information (202) configured for WWAN gateway 104 in order to facilitate IP data plane communications for each of Tenant1 110(1) and Tenant2 110(2) via any PDU session(s) that may be established by WWAN gateway 104.

For example, consider onboarding operations that can be performed for Tenant 1/WLAN AP 112(1) in which per-tenant PDU session establishment for Tenant1 can be triggered by WWAN gateway 104 upon determining/obtaining a per-tenant-First Sign of Life (FSOL) indication for Tenant1.

As shown at 214a of FIG. 2B, consider that wireless device 114(1) connects to WLAN AP 112(1) for a WLAN (e.g., Wi-Fi) connection and completes an 802.1 authentication/connection with the WLAN AP 112(1), as shown at 214b. As shown at 216a, the wireless device 114(1) initiates a Dynamic Host Configuration Protocol (DHCP)/Stateless Address Auto-configuration (SLAAC) process with the WLAN AP 112(1) to obtain an IP address for the wireless device 114(1) [the SLAAC process can include a Router Solicitation (RS) message being sent by the wireless device 114(1)]. As shown at 216b, WLAN AP 112(1) forwards the DHCP/RS message to WWAN gateway 104, via EoGRE tunnel 108(1), and includes the tenant ID for Tenant1 (T-ID(1101)) in the message.

As shown at 217, the WWAN gateway 104 uses the DHCP/RS message as a FSOL for Tenant1 110(1), as identified by the tenant ID contained in the DHCP/RS message, which causes WWAN gateway to trigger/initiate a new PDU session to be created for Tenant1 110(1) and to store message/packet obtained from the WLAN AP 112(1), for eventually responding to the wireless device with an IP address.

As shown at 218, WWAN gateway 104 sends a PDU session request for Tenant1 110(1) to AMF 142 in which the request includes the tenant ID for Tenant1 (T-ID=1101). As noted above, the tenant ID can be utilized within mobile core network 130 to facilitate various per-tenant operations/services for the Tenant1 110(1).

As shown at 219, the AMF 142 determines, based on the subscription information for the WWAN gateway 104 obtained via UDM 148 at 212, the default DNN (and slice, if applicable) for the WWAN gateway 104 and selects an SMF/UPF to handle the PDU session for Tenant1 such that, as shown at 222, the AMF 142 initiates a create Security Mode Command (SMC) context for Tenant1 (T-ID(1101)) via SMF 144, which triggers SMF 144, as shown at 224, to obtain WWAN gateway 104 subscription information and any applicable per-tenant information for Tenant1, from UDM 148. Next, as shown in FIG. 2C, the SMF 144 retrieves subscription policies (PCC rules/information) for each of the WWAN gateway 104 and Tenant 1 (using T-ID (1101)) from PCF 146, as shown at 226.

As generally shown at 228a, the SMF 144 selects a UPF, such as UPF 132, to handle the PDU session for Tenant1 and configures the UPF 132 with a Hypertext Transfer Protocol (HTTP) redirect rule, as generally shown at 228b (via an N4 session establishment exchange/process performed with UPF 132). The operations at 228a and 228b can include SMF 144 allocating an IPV6 prefix for a range/pool of IP addresses to be utilized for the PDU session/Tenant1 for data plane communications involving different wireless devices that may utilize the PDU session for Tenant1 110(1).

Further, the operations at 228a and 228b can include the SMF 144 configuring the UPF 132 with the Tenant1 110(1) tenant ID (T-ID=1101) in combination with the redirect rule that includes the address (e.g., Uniform Resource Locator (URL) or the like) for auth portal 150 in which the redirect rule indicates that Tenant1 110(1) or, more specifically, that WLAN AP 112(1), is to perform a secondary IP authentication (e.g., web authentication) via the auth portal 150 in order to authenticate/authorize IP data plane communications for the PDU session that is being established for Tenant1/WLAN AP 112(1).

Following the IPv6 prefix allocation and UPF 132 configuration, the SMF 144 initiates an NIN2 message transfer communication towards AMF 142 that includes the IPV6 prefix allocated to Tenant1 110(1) and the corresponding Tenant1 tenant ID (1101), as shown at 230, indicating successful configuration of the UPF 132 for the PDU session, which triggers AMF 142 to send a PDU session establishment accept message to WWAN gateway 104, as shown at 232, indicating that the PDU session for Tenant1 is successfully established, which, for the present example, is considered to be Tenant1 WWAN PDU session 126(1), as shown in FIG. 1, as further referenced in discussions herein.

The PDU session establishment accept message sent to WWAN gateway 104 at 232 can include the IPV6 prefix for the range/pool of IP addresses allocated to Tenant1 along with the Tenant1 tenant ID (1101).

Obtaining the indication of successful PDU session establishment by the WWAN gateway 104 triggers the WWAN gateway 104, as generally shown at 234, to assign the IPV6 prefix to Tenant1 110(1) such that the tunnel mapping information can be updated for Tenant1 to include the IPv6 prefix allocated to Tenant1 and uplink (UL)/downlink (DL) forwarding rules can be configured for Tenant1 (e.g., indicating that DL packets received via the ingress EoGRE port for tunnel 108(1)/Tenant1 are to be forwarded to WWAN PDU session 126(1) and that UL packets received for Tenant1 are to be forwarded to WLAN AP 112(1) via the EoGRE port for tunnel 108(1)/Tenant1). Further at 234, the WWAN gateway 104 can allocate an IPV6 address to be assigned to wireless device 114(1) from the IPV6 prefix address pool allocated by SMF 144 to Tenant1.

As shown at 236 of FIG. 2D, a DHCP response/acknowledgment (ACK) message is sent to the wireless device 114(1) via EoGRE tunnel 108(1)/WLAN AP 112(1) in which the message includes the IPV6 address allocated to the wireless device 114(1).

Moving to 238, consider that the wireless device 114(1) initiates a data plane communication, via the WLAN AP 114(1) connection, such as opening a web/HTTP page, for example, ‘www.example.com’, in which the communication is sent via WLAN AP 114(1)/EoGRE tunnel 108(1) to WWAN gateway 104. The WLAN AP 114(1) can include the Tenant1 tenant ID (T-ID(1101)) in the communication sent over the tunnel to the WWAN gateway 104.

At 240, the WWAN gateway 104 creates a GTP-U packet, inserts the Tenant1 tenant ID into the GTP-U header and the GTP-U payload includes information related to the web page (e.g., URL, etc.), and sends the packet to the UPF 132 via the WWAN PDU session 126(1) established for Tenant1, as shown at 242.

Upon obtaining the GTP-U packet, as generally illustrated at 244a, the UPF 132, either based on a local status or by querying the SMF 144 in accordance with the redirect rule (configured at 228), determines that the (secondary) authentication for Tenant1 (T-ID=1101) has not yet been performed and initiates a redirect toward Tenant1/WLAN AP 112(1), as shown at 244b.

At 244b, for example, the UPF 132 sends a GTP-U packet to WWAN gateway 104 in which the GTP-U header includes the Tenant1 tenant ID (T-ID(1101)) and the GTP-U payload includes an HTTP 302 redirect message including the URL for the redirect to the auth portal 150 (e.g., ‘www.portal.com/login’). Using the Tenant1 tenant ID (T-ID(1101)) included in the GTP-U header and the stored mapping information, WWAN gateway 104 forwards the redirect message to the WLAN AP 112(1) via associated EoGRE tunnel 108(1), as shown at 244c.

Upon receiving the redirect message, the WLAN AP 112(1) is triggered to perform an authentication login process with the auth portal 150, as generally shown at 246, in which the WLAN AP 112(1) provides Tenant1 authentication credentials, such as a Tenant1 user ID and corresponding password, that can match such information stored via the auth portal 150, which can be used to successfully complete the secondary authentication process to authorize IP data communications for Tenant1 (e.g., any wireless devices initiating such communications via WLAN AP 112(1)) that involve the WWAN PDU session 126(1) established for Tenant1 110(1). It is to be understood that the mobile core communications involved in the exchange at 246 can include appropriate GTP-U header information, etc. as discussed above.

As noted above, in at least one embodiment, tenants for a venue, such as venue 102, contract with an MNO/SP that is to provide WWAN connectivity for the venue such that tenant IDs for each tenant can effectively subscribe for different levels of service that can be provided through a shared WWAN gateway/CPE provided for the venue. Through such a contract/subscription process, in at least one embodiment, authentication credentials for Tenant1, such as the Tenant1 user ID and password, can be configured for use with the auth portal 150 in order to facilitate successful completion of the secondary authentication exchange that can serve as registration and onboarding of the Tenant1/WLAN AP 112(1), which can be used to authorize IP data communications for Tenant1/WLAN AP 112(1) via WWAN PDU session 126(1), as generally shown at 247 of FIG. 2E.

Although not shown in FIGS. 2D and 2E, in some embodiments, secondary authentication for a given tenant can involve AAA 154 of mobile core network 130, in lieu of and/or in addition to auth portal 150. For example, in at least one embodiment, auth portal 150 may merely receive an auth request initiated by a WLAN AP of a given tenant that includes the tenant ID of the tenant such that the auth portal 150 may perform an authentication exchange with AAA 154 using the tenant ID for the given tenant in order to obtain and/or verify authentication credentials for the given tenant. Thus, in accordance with embodiments herein, different secondary authentication mechanisms can be envisioned for authenticating a tenant for IP data communications to be provided via a given WWAN PDU session involving the tenant.

Returning to FIG. 2E, following successful completion of the secondary authentication process performed via auth portal 150, an authentication success message can be sent to the SMF 144, as shown at 248, that includes the Tenant1 tenant ID (T-ID(1101)), which triggers the SMF 144 to remove the redirect rule from UPF 132 for Tenant1, as shown at 250.

Thereafter, as shown at 252a, 252b, and 252c, IP data plane communications (data traffic) can be performed between wireless device 114(1), WLAN AP 112(1), WWAN gateway 104, and UPF 132 (as well as for the DNN1, although not shown in FIG. 2E) via the WWAN PDU session 126(1) for Tenant1 in which the WLAN AP 112(1) can include the Tenant1 tenant ID (T-ID (1101)) in traffic sent to WWAN gateway 104, which can further include the Tenant1 tenant ID (T-ID(1101)) in the GTP-U header of DL GTP-U packets sent to UPF 132. Similarly, UPF 132 can include the Tenant1 tenant ID (T-ID(1101)) in the GTP-U header of UL GTP-U packets sent to WWAN gateway 104, which can use the Tenant 1 tenant ID to map the data traffic to the EoGRE tunnel 108(1) for communication to WLAN AP 112(1), for transmission to wireless device 114(1).

Further for the IP data plane communications, as shown at 254, on receiving data traffic involving the WWAN PDU session 126(1) of Tenant1, UPF 132 can use the Tenant1 tenant ID (T-ID(1101)) and/or the IP prefix/IP address for the communications in order to perform packet counting for the communications involving the PDU session and apply UL QoS rules for the communications (per the Tenant1 PCC rules), and send URRs to the SMF 144 for Tenant1 to facilitate charging for the Tenant1 communications. For example, as shown at 256, UPF 132 can send URRs to SMF 144 that include the Tenant1 tenant ID (T-ID(1101)), which can trigger the SMF 144, as shown at 258, to generate CDRs for Tenant1 in which the CDRs include the Tenant1 tenant ID along with the WWAN gateway 104 subscription identifier (SUPI=104) and an indication that the charging data involves a shared WWAN gateway (e.g., which can be used for different policy control mechanisms for charging, billing, etc.).

Thus, as shown through FIGS. 2A, 2B, 2C, 2D, and 2E, a per-tenant WWAN PDU session can be established for a tenant of a venue, such as Tenant1 110(1), in which data plane communications involving the tenant or, more specifically, any number of wireless devices served at the tenant location, can involve on-premise WLAN communications for the wireless devices, wired communications between the tenant WLAN AP and a shared, on-premise WWAN gateway, and WWAN (e.g., 5G) communications.

For the embodiments of FIGS. 2A-2H, additional per-tenant WWAN PDU sessions can be established for any other tenants that may be served by venue 102/WWAN gateway 104. Operations involving additional per-tenant WWAN PDU sessions for the embodiments of FIG. 2A-2H may be similar to those as discussed for Tenant1 110(1), with changes based on IP prefix allocation, tenant specific QoS policies, charging, etc. as discussed in further detail herein, below.

For example, consider, as further shown in FIG. 2F at 260a, that wireless device 114(2) connects to WLAN AP 112(2) for a WLAN (e.g., Wi-Fi) connection and completes an 802.1 authentication/connection with the WLAN AP 112(2), as shown at 260b. As shown at 262a, the wireless device 114(2) initiates a DHCP/SLAAC process with the WLAN AP 112(2) to obtain an IP address for the wireless device 114(2). As shown at 262b, WLAN AP 112(2) forwards the DHCP/RS message to WWAN gateway 104, via EoGRE tunnel 108(2), and includes the tenant ID for Tenant2 (T-ID(1102)) in the message.

As shown generally shown at 264 (similar to operations 217, 218, 219, 222, 224, and 226, as discussed above for Tenant1), the WWAN gateway 104 uses the DHCP/RS message as a FSOL for Tenant2 110(2), as identified by the tenant ID contained in the DHCP/RS message (T-ID (1102)), which causes WWAN gateway 104 to trigger/initiate a new PDU session to be created for Tenant2 110(1) and to store message/packet obtained from the WLAN AP 112(1). For example, WWAN gateway 104 can send a PDU session request for Tenant2 110(2) to AMF 142 in which the request includes the tenant ID for Tenant2 (T-ID(1102)). The AMF 142 can determine, based on the subscription information for the WWAN gateway 104 obtained via UDM 148 at 212, the default DNN (and slice, if applicable) for the WWAN gateway 104 and selects an SMF/UPF to handle the PDU session for Tenant2. For example, the AMF 142 can initiate (e.g., as shown/discussed for 222, above, involving Tenant1) creation of SMC context for Tenant2 (T-ID (1102)) via SMF 144, which triggers SMF 144, to obtain WWAN gateway 104 subscription information and any applicable per-tenant information for Tenant2, from UDM 148 (e.g., as shown/discussed for 224, above, involving Tenant1). The SMF 144 can also retrieve subscription policies (PCC rules/information) for each of the WWAN gateway 104 and Tenant2 (using T-ID (1102)) from PCF 146 at 264.

Thereafter, as generally shown at 266a, the SMF 144 selects a UPF, such as UPF 132, to handle the PDU session for Tenant2 and configures the UPF 132 with a HTTP redirect rule, as generally shown at 266b of FIG. 2G (via an N4 session establishment exchange/process performed with UPF 132). The operations at 266a and 266b can include SMF 144 allocating an IPV6 prefix for a range/pool of IP addresses to be utilized for the PDU session for Tenant2 110(2) for data plane communications involving different wireless devices that may utilize the PDU session for Tenant2 110(2).

The operations at 266a and 266bb can include the SMF 144 configuring the UPF 132 with the Tenant2 110(2) tenant ID (T-ID=1102) in combination with the redirect rule that includes the address (e.g., URL or the like) for auth portal 150 in which the redirect rule indicates that Tenant2 110(2) or, more specifically, that WLAN AP 112(2), is to perform a secondary IP authentication (e.g., web authentication) via the auth portal 150 in order to authenticate/authorize IP data plane communications for the PDU session that is being established for Tenant2/WLAN AP 112(2).

Following the Ipv6 prefix allocation and UPF 132 configuration, the SMF 144 initiates an NIN2 message transfer communication towards AMF 142 that includes the Ipv6 prefix allocated to Tenant2 110(2) and the corresponding Tenant2 tenant ID (1102), as shown at 268, indicating successful configuration of the UPF 132 for the PDU session, which triggers AMF 142 to send a PDU session establishment accept message to WWAN gateway 104, as shown at 270, indicating that the PDU session for Tenant2 is successfully established, which for the present example, is considered to be Tenant2 WWAN PDU session 126(2), as shown in FIG. 1, as further referenced in discussions herein.

The PDU session establishment accept message sent to WWAN gateway 104 at 270 can include the Ipv6 prefix for the range/pool of IP addresses allocated to Tenant2 along with the Tenant2 tenant ID (1102).

Obtaining the indication of successful PDU session establishment by the WWAN gateway 104 triggers the WWAN gateway 104, as generally shown at 272, to assign the Ipv6 prefix to Tenant2 110(2) such that the tunnel mapping information can be updated for Tenant2 to include the Ipv6 prefix allocated to Tenant2 and UL/DL forwarding rules can be configured for Tenant2 (e.g., indicating that DL packets received via the ingress EoGRE port for tunnel 108(2)/Tenant2 are to be forwarded to WWAN PDU session 126(2) and that UL packets received for Tenant2 are to be forwarded to WLAN AP 112(2) via the EoGRE port for tunnel 108(2)/Tenant2). Further at 272, the WWAN gateway 104 can allocate an Ipv6 address to be assigned to wireless device 114(2) from the Ipv6 prefix address pool allocated by SMF 144 to Tenant2.

As shown at 274, a DHCP response/ACK message is sent to the wireless device 114(2) via EoGRE tunnel 108(2)/WLAN AP 112(2) in which the message includes the Ipv6 address allocated to the wireless device 114(2).

Moving to 276, consider that the wireless device 114(1) initiates a data plane communication, via the WLAN AP 114(2) connection, such as opening a web/HTTP page, for example, ‘www.example.com’, in which the communication is sent via WLAN AP 114(2)/EoGRE tunnel 108(2) to WWAN gateway 104. The WLAN AP 114(2) includes the Tenant2 tenant ID (T-ID (1102)) in the communication sent over the tunnel to the WWAN gateway 104.

As generally shown at 278 (similar to operations 240, 242, 244a, 244b, 244c, and 246 as discussed above for Tenant1), the WWAN gateway 104 creates a GTP-U packet, inserts the Tenant2 tenant ID into the GTP-U header and the GTP-U payload includes information related to the web page (e.g., URL, etc.), and sends the packet to the UPF 132 via the WWAN PDU session 126(2) established for Tenant2. Upon obtaining the GTP-U packet, the UPF 132 either based on a local status or by querying the SMF 144 in accordance with the redirect rule configured for the Tenant2 PDU session determines that the (secondary) authentication for Tenant2 (T-ID=1102) has not yet been performed and initiates a redirect toward Tenant2/WLAN AP 112(2). For example, the UPF 132 sends a GTP-U packet to WWAN gateway 104 in which the GTP-U header includes the Tenant2 tenant ID (T-ID(1102)), and the GTP-U payload includes an HTTP 302 redirect message including the URL for the redirect to the auth portal 150 (e.g., ‘www.portal.com/login’). Using the Tenant2 tenant ID (T-ID(1102)) included in the GTP-U header and the stored mapping information, WWAN gateway 104 forwards the redirect message to the WLAN AP 112(2) via associated EoGRE tunnel 108(2). Upon receiving the redirect message, the WLAN AP 112(2) is triggered to perform an authentication login process with the auth portal 150 in which the WLAN AP 112(2) provides Tenant2 authentication credentials, such as a Tenant2 user ID and corresponding password, that can match such information stored via the auth portal 150, which can be used to successfully complete the secondary authentication process to authorize IP data communications for Tenant2 (e.g., any wireless devices initiating such communications via WLAN AP 112(2) that involve the WWAN PDU session 126(2) established for Tenant2 110(2).

Successful completion of the secondary authentication exchange can serve as registration and onboarding of the Tenant2/WLAN AP 112(2), which can be used to authorize IP data communications for Tenant2/WLAN AP 112(2) via WWAN PDU session 126(2), as generally shown at 279 of FIG. 2H.

Following successful completion of the secondary authentication process performed via auth portal 150, an authentication success message can be sent to the SMF 144, as shown at 280 that includes the Tenant2 tenant ID (T-ID(1102)), which triggers the SMF 144 to remove the redirect rule from UPF 132 for Tenant2, as shown at 282.

Thereafter, as shown at 284a, 284b, and 284c, IP data plane communications (data traffic) can be performed between wireless device 114(2), WLAN AP 112(2), WWAN gateway 104, and UPF 132 (as well as for the DNN1, although not shown in FIG. 2H) via the WWAN PDU session 126(2) for Tenant2 in which the WLAN AP 112(2) can include the Tenant2 tenant ID (T-ID (1102)) in traffic sent to WWAN gateway 104, which can further include the Tenant2 tenant ID (T-ID(1102)) in the GTP-U header of DL GTP-U packets sent to UPF 132. Similarly, UPF 132 can include the Tenant2 tenant ID (T-ID(1102)) in the GTP-U header of UL GTP-U packets sent to WWAN gateway 104, which can use the Tenant2 tenant ID to map the data traffic to the EoGRE tunnel 108(2) for communication to WLAN AP 112(2), for transmission to wireless device 114(2).

Further for the IP data plane communications, as shown at 286, on receiving data traffic involving the WWAN PDU session 126(2) of Tenant2, UPF 132 can use the Tenant2 tenant ID (T-ID(1102)) and/or the IP prefix/IP address for the communications in order to perform packet counting for the communications involving the PDU session and apply UL QOS rules for the communications (per the Tenant2 PCC rules), and send URRs to the SMF 144 for Tenant2 to facilitate charging for the Tenant2 communications. For example, as shown at 288, UPF 132 can send URRs to SMF 144 that include the Tenant2 tenant ID (T-ID(1102)), which can trigger the SMF 144, as shown at 290, to generate CDRs for Tenant2 in which the CDRs include the Tenant2 tenant ID along with the WWAN gateway 104 subscription identifier (SUPI=104) and an indication that the charging data involves a shared WWAN gateway.

Thus, as shown through FIGS. 2A, 2B, 2C, 2D, 2E, 2F, 2G, and 2H, any number of per-tenant WWAN PDU sessions can be established for any number of tenants of a venue that may share access to a WWAN mobile core network through a shared WWAN/5G CPE device, such as WWAN gateway 104, in which data plane communications involving each of multiple tenants or, more specifically, any number of wireless devices served at each tenant location, can involve on-premise WLAN communications for the wireless devices, wired communications between the tenant WLAN AP and a shared, on-premise WWAN gateway, and WWAN (e.g., 5G) communications involving per-tenant PDU sessions.

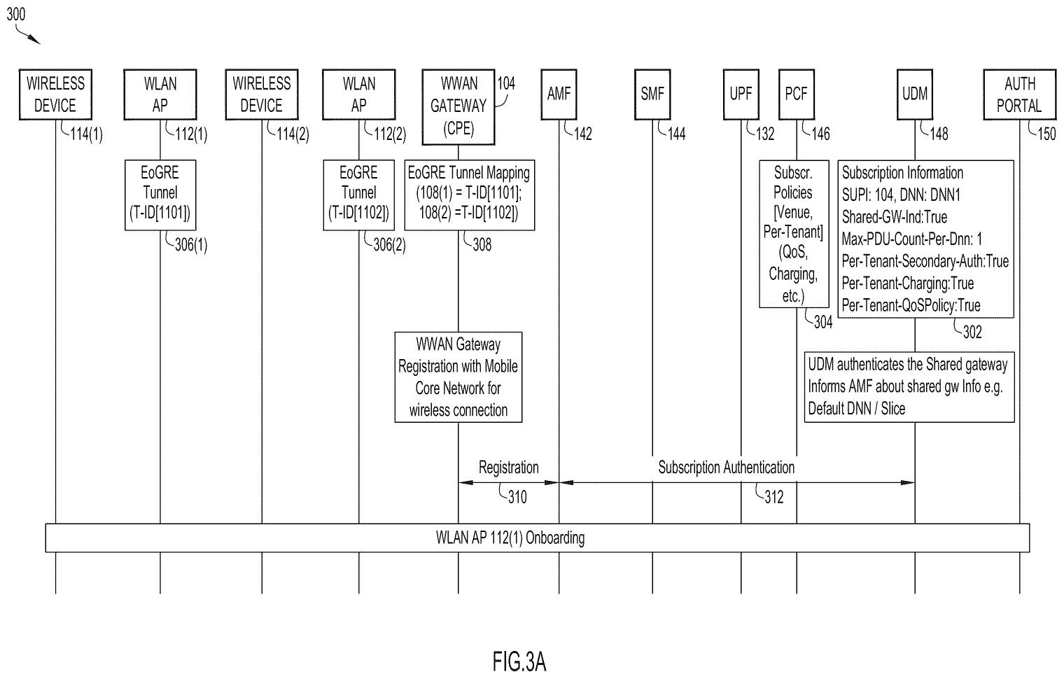

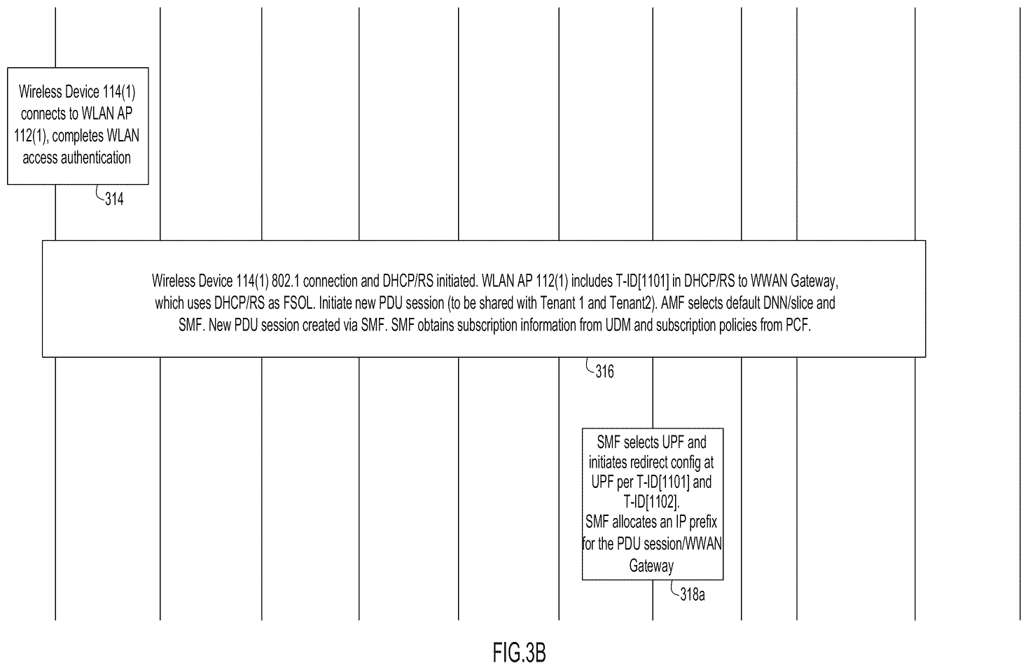

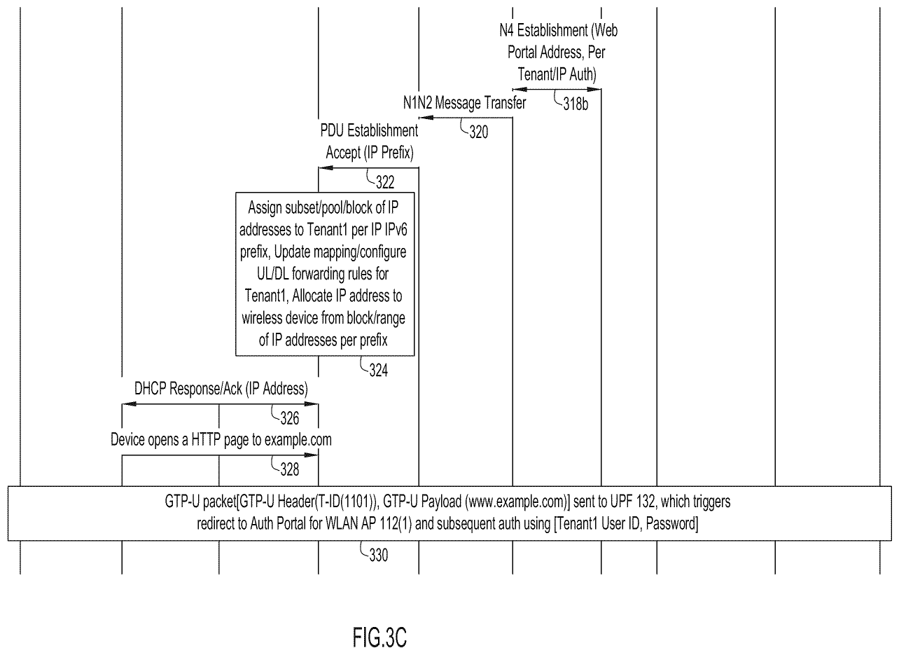

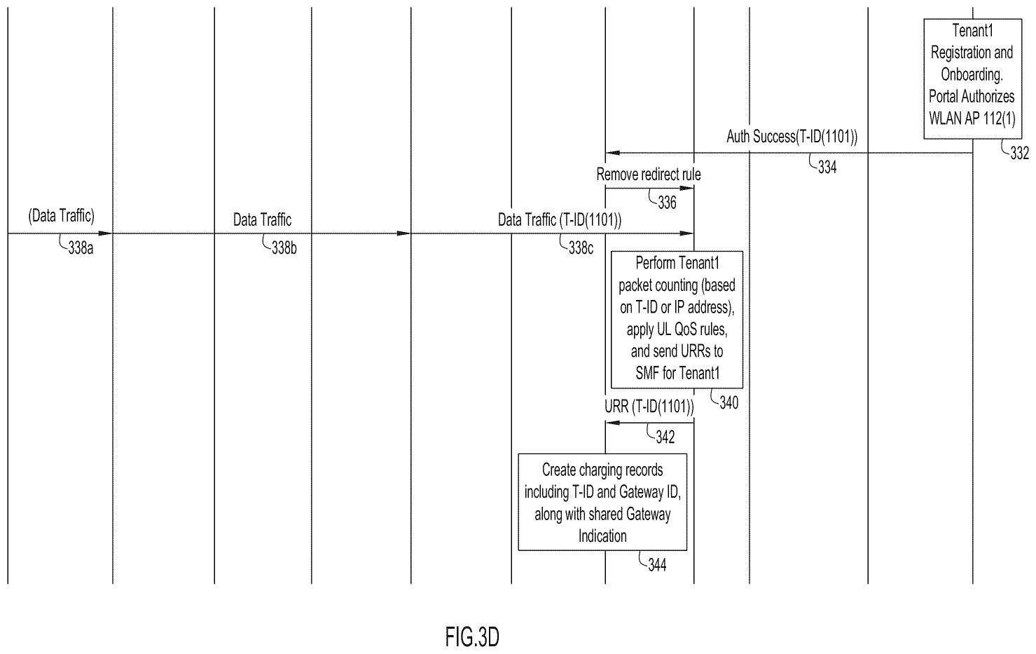

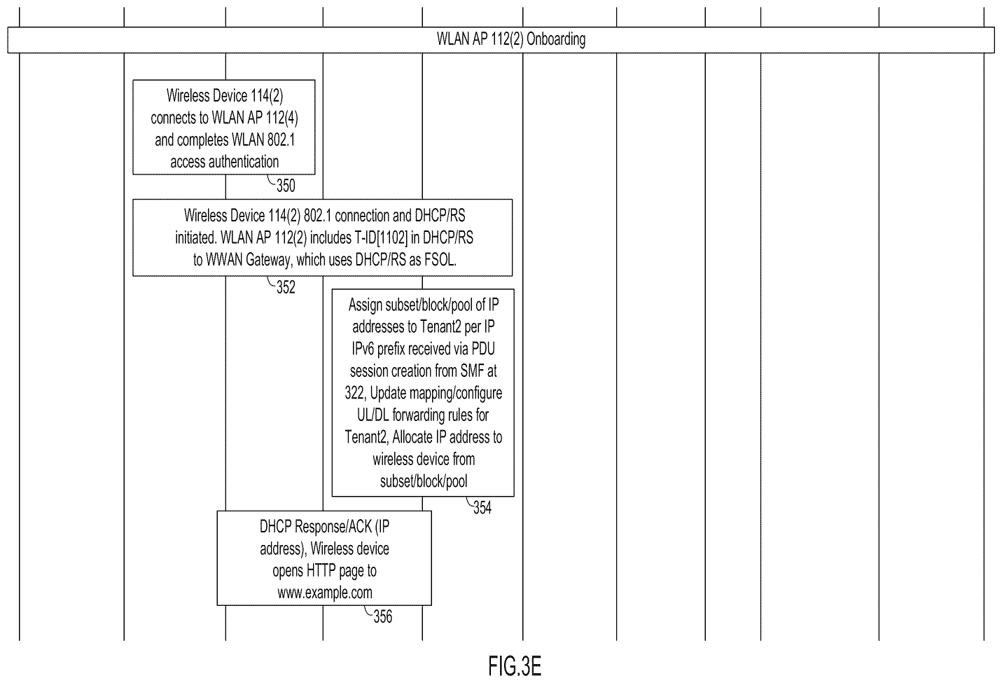

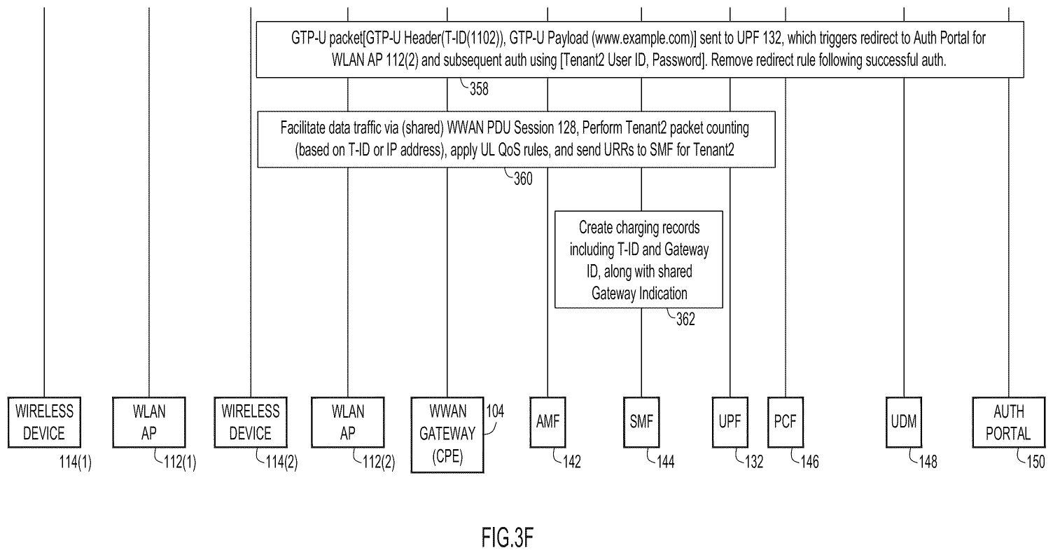

Recall, however, as discussed above, that embodiments of the present disclosure, for also provide for utilizing a shared WWAN gateway by multiple tenants of a venue through a WWAN PDU session that can be shared among the multiple tenants. Referring to FIGS. 3A, 3B, 3C, 3D, 3E, and 3F, FIGS. 3A, 3B, 3C, 3D, 3E, and 3F are a message sequence diagram 300 illustrating various example operations that may be performed to facilitate on-premise WWAN equipment sharing in a multi-tenant environment in which a single WWAN PDU session can be shared by Tenant1 110(1) and Tenant2 110, according to an example embodiment.

FIGS. 3A-3F include wireless device 114(1) and WLAN AP 112(1) associated with Tenant1 110(1) location, wireless device 114(2) and WLAN AP 112(2) associated with Tenant2 110(2) location, WWAN gateway 104 (including eSIM profile 105). Also shown in FIGS. 3A-3F are AMF 142, SMF 144, UPF 132, PCF 146, UDM 148, and auth portal 150 of mobile core network 130. WWAN 120 including radio node 122 is not shown in FIGS. 3A-3F for purposes of brevity only; however, it is to be understood that WWAN gateway 104 can connect to/interface with any elements/functions of mobile core network 130 via a corresponding wireless connection with the WWAN 120/radio node 122 in order to facilitate various operations discussed herein.

As shown at 302, consider that various subscription information for one or more UE of system 100, such as for WWAN gateway 104, can be configured for UDM 148. In at least one embodiment, the subscription information configured at 302 for WWAN gateway 104 can include a subscription identifier for WWAN gateway 104, such as the SUPI provided for the WWAN gateway 104 (e.g., SUPI=104) and a default DNN for PDU session(s) that can be established for the WWAN gateway 104, such as identifying DNN1 162(1) (e.g., Internet).

The subscription information configured at 302 may be similar to the subscription information as discussed above at 202 of FIG. 2A; however, for 302 of FIG. 3A, consider that the indication of the maximum number of PDU sessions per DNN configured for WWAN gateway is set to 1 (e.g., ‘Max-PDU-Count-Per-Dnn=1’). As noted above, for the embodiments of FIGS. 3A-3C, each of Tenant1 110(1) and Tenant2 110(2) are to share a WWAN PDU session established for data plane communications. Further, as shown at 304, subscription policy information (e.g., venue and per tenant PCC rules/information) can be configured at PCF 146 and include information similar to that as discussed above at 204 of FIG. 2A (e.g., QOS rules can be based on source IP, application type or other considerations, which can allow the definition of QoS rules unique to each tenant).

Operations for the example embodiments of FIGS. 3A-3F can include, as generally shown at 306(1) and 306(2), each of WLAN AP 112(1) for Tenant1 110(1) location and WLAN AP 112(2) for Tenant2 110(2) location performing an auto-discovery process with the WWAN gateway 104 and setting up, via corresponding wired connections (106(1) and 106(2)) with the WWAN gateway 104, a corresponding dedicated EoGRE tunnel with the WWAN gateway 104, such as EoGRE tunnel 108(1) for WLAN AP 112(1) and EoGRE tunnel 108(2) for WLAN AP 112(2). The WWAN gateway 104 can assign a tenant ID to each of Tenant1, such as ‘T-ID=1101’, and Tenant2, such as ‘T-ID=1102’. Each corresponding assigned tenant ID can be provided to each corresponding WLAN AP 112(1) and WLAN AP 112(2) for use with various operations/communications involving each corresponding EoGRE tunnel 108(1) and EoGRE tunnel 108(2).

As shown at 308, the WWAN gateway 104 maintains tunnel mapping information, such a per-tenant tunnel/tenant ID mapping (e.g., EoGRE tunnel 108(1)=T-ID (1101), EoGRE tunnel 108(2)=T-ID (1102)). The WWAN gateway 104 can update the tunnel mapping information with additional per-tenant information, such as IP prefix information, PDU session identifier information, etc. for additional operations provided by WWAN gateway 104 through operations discussed for embodiments herein.

Following tunnel establishment, tenant ID assignment, and mapping operations, WWAN gateway 104 can perform a registration process with the mobile core network 130 in order to establish WWAN/5G wireless connectivity between WWAN gateway 104 and mobile core network 130. For example, as shown at 310, WWAN gateway 104 initiates a mobile network registration with AMF 142 (via WWAN 120/radio node 122), which triggers AMF 142 to obtain subscription information and perform an authentication process to authenticate/authorize WWAN gateway 104 to connect to mobile core network 130 through subscription information obtained for WWAN gateway 104 from UDM 148, as shown at 312. Such operations at 310 and 312 can include standards-based authentication/authorization operations performed based on the eSIM profile 105 provided for WWAN gateway 104 involving the SUPI for the gateway.

Consider various onboarding operations that can be performed for Tenant 1/WLAN AP 112(1) in which PDU session establishment for a shared PDU session can be triggered by WWAN gateway 104 upon determining/obtaining a FSOL indication, for example, for Tenant1.

Consider, for example, as generally shown at 314 of FIG. 3B (similar to operations as discussed at 214a and 214b as discussed for FIG. 2B), that wireless device 114(1) connects to WLAN AP 112(1) for a WLAN (e.g., Wi-Fi) connection and completes an 802.1 authentication/connection with the WLAN AP 112(1).

Further, as generally shown at 316 (similar to operations 216a, 216b, 217, 218, 219, 222, 224, and 226, as discussed above for FIGS. 2B and 2C), consider that wireless device 114(1) initiates a DHCP/SLAAC process with the WLAN AP 112(1) to obtain an IP address for the wireless device 114(1), and that WLAN AP 112(1) forwards the DHCP/RS message to WWAN gateway 104, via EoGRE tunnel 108(1), and includes the tenant ID for Tenant1 (T-ID(1101)) in the message.

Further at 316, the WWAN gateway 104 can use the DHCP/RS message as a FSOL for Tenant1 110(1), as identified by the tenant ID contained in the DHCP/RS message, which causes WWAN gateway 104 to trigger/initiate a new PDU session to be created in which the PDU session is to be shared among Tenant1 and Tenant2. For example, WWAN gateway 104 can send a PDU session request to AMF 142. For the embodiment of FIGS. 3A-3F, it is assumed that the mobile core network can be preconfigured with or obtain via an out-of-band mechanism (e.g., subscription, etc.) the tenant IDs for each of Tenant1 and Tenant2 that are to utilize the shared PDU session.

The AMF 142 can determine, based on the subscription information for the WWAN gateway 104 obtained via UDM 148, the default DNN (and slice, if applicable) for the WWAN gateway 104 and selects an SMF/UPF to handle the PDU session. For example, the AMF 142 can initiate creation of SMC context for the session, which triggers SMF 144, to obtain WWAN gateway 104 subscription information and any applicable per-tenant information, from UDM 148. The SMF 144 can also retrieve subscription policies (PCC rules/information) for each of the WWAN gateway 104 and both of Tenant 1 and Tenant2 from PCF 146, since both tenants are to share the PDU session.

Thereafter, as generally shown at 318a, the SMF 144 selects a UPF, such as UPF 132, to handle the PDU session and configures the UPF 132 with HTTP redirect rules, as generally shown at 318b of FIG. 3C (via an N4 session establishment exchange/process performed with UPF 132), for each of Tenant1 and Tenant2. In at least one embodiment, the operations at 318b can be performed separately to configure the redirect rule for each of Tenant1 and Tenant2.

The operations at 318a and 318b can include SMF 144 allocating an IPV6 prefix for a range/pool of IP addresses to be utilized for the PDU session for each of Tenant1 and Tenant2 for data plane communications involving different wireless devices that may utilize the PDU session for Tenant1 and Tenant2. In at least one embodiment, an overall IPv6 prefix can be allocated for use by all tenants for a venue, and different subnetwork ranges or subsets/pools/blocks of IP addresses for the IPV6 prefix can be allocated to different tenants.

Following the IPv6 prefix allocation and UPF 132 configuration, the SMF 144 initiates an NIN2 message transfer communication towards AMF 142 that includes the IPV6 prefix or, in some embodiments the allocated IPv6 prefix and the different subsets/pools/blocks of IP address for the IPV6 prefix that are allocated to each of Tenant1 and Tenant2, as shown at 320, indicating successful configuration of the UPF 132 for the PDU session, which triggers AMF 142 to send a PDU session establishment accept message to WWAN gateway 104, as shown at 232, indicating that the PDU session is successfully established, which, for the present example, is considered to be WWAN PDU session 128, as shown in FIG. 1, as further referenced in discussions herein that is to be shared by Tenant1 110(1) and Tenant2 110(2).

The PDU session establishment accept message sent to WWAN gateway 104 at 320 can include the IPV6 prefix allocated by the SMF 144 or, in some embodiments the allocated IPV6 prefix and the different subsets/pools/blocks of IP address for the IPV6 prefix that are allocated to each of Tenant1 and Tenant2.

Obtaining the indication of successful PDU session establishment by the WWAN gateway 104 triggers the WWAN gateway 104, as generally shown at 324, to assign a subset/pool/block of IP addresses for the IPV6 prefix to Tenant1 110(1) such that the tunnel mapping information can be updated for Tenant1 to include the subset/pool/block of IP addresses for the IPV6 prefix assigned to Tenant1, and UL/DL forwarding rules can be configured for Tenant1. In some embodiments, if WWAN gateway 104 receives only an IPv6 prefix in a PDU session establishment accept message, the WWAN gateway 104 can determine/apportion the subset/pool/block of IP addresses to be allocated to/among each of multiple tenants. However, in some embodiments, WWAN gateway 104 can receive an explicit indication of the subset/pool/block of IP address that are to be allocated to each of multiple tenants for a given IPv6 prefix.

Further at 324, the WWAN gateway 104 can allocate an IPv6 address to be assigned to wireless device 114(1) from the subset/pool/block of IP addresses for the IPv6 prefix assigned to Tenant1. At 326, a DHCP response/ACK message is sent to the wireless device 114(1) via EoGRE tunnel 108(1)/WLAN AP 112(1) in which the message includes the IPV6 address allocated to the wireless device 114(1).

Moving to 328, consider that the wireless device 114(1) initiates a data plane communication, via the WLAN AP 114(1) connection, such as opening a web/HTTP page, for example, ‘www.example.com’, in which the communication is sent via WLAN AP 114(1)/EoGRE tunnel 108(1) to WWAN gateway 104.

As generally shown at 330 (similar to operations 240, 242, 244a, 244b, 244c, and 246 as discussed above for FIGS. 2D), the WWAN gateway 104 creates a GTP-U packet, inserts the Tenant1 tenant ID into the GTP-U header (T-ID(1101)) and the GTP-U payload includes information related to the web page (e.g., URL, etc.), and sends the packet to the UPF 132 via the WWAN PDU session 128. Upon obtaining the GTP-U packet, the UPF 132, either based on a local status or by querying the SMF 144 in accordance with the redirect rule configured for Tenant1, determines that the (secondary) authentication for Tenant1 (T-ID=1101) has not yet been performed and initiates a redirect toward Tenant 1/WLAN AP 112(1).

For example, the operations at 330 can include UPF 132 sending a GTP-U packet to WWAN gateway 104 in which the GTP-U header includes the Tenant1 tenant ID (T-ID(1101)), and the GTP-U payload includes an HTTP 302 redirect message including the URL for the redirect to the auth portal 150 (e.g., ‘www.portal.com/login’). Using the Tenant 1 tenant ID (T-ID(1101)) included in the GTP-U header and the stored mapping information, WWAN gateway 104 forwards the redirect message to the WLAN AP 112(1) via associated EoGRE tunnel 108(1). Upon receiving the redirect message, the WLAN AP 112(1) is triggered to perform an authentication login process with the auth portal 150 in which the WLAN AP 112(1) provides Tenant1 authentication credentials, such as a Tenant1 user ID and corresponding password, that can match such information stored via the auth portal 150, which can be used to successfully complete the secondary authentication process to authorize IP data communications for Tenant 1 (e.g., any wireless devices initiating such communications via WLAN AP 112(1) that involve the WWAN PDU session 128).

Successful completion of the secondary authentication exchange can serve as registration and onboarding of the Tenant1/WLAN AP 112(1), which can be used to authorize IP data communications for Tenant1/WLAN AP 112(1) via WWAN PDU session 128, as generally shown at 332 of FIG. 3D.

Following successful completion of the secondary authentication process performed via auth portal 150, an authentication success message can be sent to the SMF 144, as shown at 334, that includes the Tenant1 tenant ID (T-ID(1101)), which triggers the SMF 144 to remove the redirect rule from UPF 132 for Tenant1, as shown at 336.

Thereafter, as shown at 338a, 338b, and 338c, IP data plane communications (data traffic) can be performed between wireless device 114(1), WLAN AP 112(1), WWAN gateway 104, and UPF 132 (as well as for the DNN1, although not shown in FIG. 3D) via the WWAN PDU session 128 in which the WLAN AP 112(1) can include the Tenant1 tenant ID (T-ID(1101)) in traffic sent to WWAN gateway 104, which can further include the Tenant 1 tenant ID (T-ID(1101)) in the GTP-U header of DL GTP-U packets sent to UPF 132. Similarly, UPF 132 can include the Tenant1 tenant ID (T-ID(1101)) in the GTP-U header of UL GTP-U packets sent to WWAN gateway 104, which can use the Tenant1 tenant ID to map the data traffic to the EoGRE tunnel 108(1) for communication to WLAN AP 112(1), for transmission to wireless device 114(1).

Further for the IP data plane communications, as shown at 340, on receiving data traffic involving the WWAN PDU session 128, UPF 132 can use the Tenant1 tenant ID (T-ID(1101)) and/or the IP prefix/IP address for the communications in order to perform packet counting for the communications involving the PDU session and apply UL QoS rules for the communications (per the Tenant1 PCC rules), and send URRs to the SMF 144 for Tenant 1 to facilitate charging for the Tenant1 communications. For example, as shown at 342, UPF 132 can send URRs to SMF 144 that include the Tenant 1 tenant ID (T-ID(1101)), which can trigger the SMF 144, as shown at 344, to generate CDRs for Tenant1 in which the CDRs include the Tenant1 tenant ID along with the WWAN gateway 104 subscription identifier (SUPI=104) and an indication that the charging data involves a shared WWAN gateway.

Moving to FIG. 3E, consider various operations that can be performed to facilitate on-boarding for WLAN AP 112(2) involving Tenant2's use of the shared WWAN PDU session 128. For example, as generally shown at 350 that wireless device 114(2) connects to WLAN AP 112(2) for a WLAN (e.g., Wi-Fi) connection and completes an 802.1 authentication/connection with the WLAN AP 112(2). At 352, consider that wireless device 114(2) initiates a DHCP/SLAAC process with the WLAN AP 112(2) to obtain an IP address for the wireless device 114(2), and that WLAN AP 112(2) forwards the DHCP/RS message to WWAN gateway 104, via EoGRE tunnel 108(2), and includes the tenant ID for Tenant2 (T-ID(1102)) in the message in which the WWAN gateway 104 can use the DHCP/RS message as a FSOL for Tenant2 110(2), as identified by the tenant ID contained in the DHCP/RS message.

Different than the operations discussed above for Tenant1/WLAN AP 112(1), the WWAN gateway 104 for the embodiments of FIGS. 3A-3F uses the FSOL for Tenant2 110(2) to trigger, since the WWAN PDU session 128 is already established, operations that involve the WWAN gateway 104 assigning the subset/block/pool of IP addresses from the IPV6 prefix obtained at 322 from SMF 144 for use with Tenant2 110(2) wireless device(s) for which communications involving the WWAN PDU session 128 are to be provided, as generally shown at 354. In some embodiments, the assignment of IP addresses to be used for Tenant2 wireless device(s) can be determined by WWAN gateway based on an explicit indication of the subset/pool/block of IP addresses to use as provided by the SMF 144. In some embodiments, assignment of IP addresses to be used for Tenant2 wireless device(s) can be determined by WWAN gateway based the gateway's own determination of the subset/pool/block of IP addresses to use based on the IPV6 prefix as provided by the SMF 144.

Further at 354, UL/DL forwarding rules can be configured for Tenant2 and the WWAN gateway 104 can allocate an IPV6 address to be assigned to wireless device 114(2) from the subset/pool/block of IP addresses for the IPv6 prefix assigned to Tenant2.

As generally shown at 356, consider that a DHCP response/ACK message is sent to the wireless device 114(2) via EoGRE tunnel 108(2)/WLAN AP 112(2) in which the message includes the IPV6 address allocated to the wireless device 114(2) and the wireless device 114(2) initiates a data plane communication, via the WLAN AP 114(2) connection, such as opening a web/HTTP page, for example, ‘www.example.com’, in which the communication is sent via WLAN AP 114(2)/EoGRE tunnel 108(2) to WWAN gateway 104.

As generally shown at 358 of FIG. 3F, the WWAN gateway 104 creates a GTP-U packet, inserts the Tenant2 tenant ID into the GTP-U header (T-ID(1102)) and the GTP-U payload includes information related to the web page (e.g., URL, etc.), and sends the packet to the UPF 132 via the WWAN PDU session 128. Upon obtaining the GTP-U packet, the UPF 132, either based on a local status or by querying the SMF 144 in accordance with the redirect rule configured for the Tenant2, PDU session determines that the (secondary) authentication for Tenant2 (T-ID=1102) has not yet been performed and initiates a redirect toward Tenant 1/WLAN AP 112(2).

For example, the operations at 358 can include UPF 132 sending a GTP-U packet to WWAN gateway 104 in which the GTP-U header includes the Tenant2 tenant ID (T-ID(1102)), and the GTP-U payload includes an HTTP 302 redirect message including the URL for the redirect to the auth portal 150 (e.g., ‘www.portal.com/login’). Using the Tenant2 tenant ID (T-ID(1102)) included in the GTP-U header and the stored mapping information, WWAN gateway 104 forwards the redirect message to the WLAN AP 112(2) via associated EoGRE tunnel 108(2). Upon receiving the redirect message, the WLAN AP 112(2) is triggered to perform an authentication login process with the auth portal 150 in which the WLAN AP 112(2) provides Tenant2 authentication credentials, such as a Tenant2 user ID and corresponding password, that can match such information stored via the auth portal 150, which can be used to successfully complete the secondary authentication process to authorize IP data communications for Tenant2 (e.g., any wireless devices initiating such communications via WLAN AP 112(2) that involve the WWAN PDU session 128).

Successful completion of the secondary authentication exchange can serve as registration and onboarding of the Tenant2/WLAN AP 112(2), which can be used to authorize IP data communications for Tenant2/WLAN AP 112(2) via WWAN PDU session 128. Following successful completion of the secondary authentication process performed via auth portal 150, an authentication success message can be sent to the SMF 144 that includes the Tenant2 tenant ID (T-ID(1102)), which triggers the SMF 144 to remove the redirect rule from UPF 132 for Tenant2, as generally shown at 358.

Thereafter, as generally shown at 360, IP data plane communications (data traffic) can be performed between wireless device 114(2), WLAN AP 112(2), WWAN gateway 104, and UPF 132 (as well as for the DNN1, although not shown in FIG. 3F) via the WWAN PDU session 128 in which the WLAN AP 112(2) can include the Tenant2 tenant ID (T-ID(1102)) in traffic sent to WWAN gateway 104, which can further include the Tenant1 tenant ID (T-ID(1102)) in the GTP-U header of DL GTP-U packets sent to UPF 132. Similarly, UPF 132 can include the Tenant2 tenant ID (T-ID(1102)) in the GTP-U header of UL GTP-U packets sent to WWAN gateway 104, which can use the Tenant2 tenant ID to map the data traffic to the EoGRE tunnel 108(2) for communication to WLAN AP 112(2), for transmission to wireless device 114(2).

Further for the IP data plane communications, as generally shown at 360, on receiving data traffic involving the WWAN PDU session 128, UPF 132 can use the Tenant2 tenant ID (T-ID (1102)) and/or the IP prefix/IP address for the communications in order to perform packet counting for the communications involving the PDU session and apply UL QOS rules for the communications (per the Tenant2 PCC rules), and send URRs to the SMF 144 for Tenant2 to facilitate charging for the Tenant2 communications. For example, UPF 132 can send URRs to SMF 144 that include the Tenant2 tenant ID (T-ID(1102)), which can trigger the SMF 144, as shown at 362, to generate CDRs for Tenant2 in which the CDRs include the Tenant2 tenant ID along with the WWAN gateway 104 subscription identifier (SUPI=104) and an indication that the charging data involves a shared WWAN gateway.

Thus, as shown through FIGS. 3A, 3B, 3C, 3D, 3E, and 3F any number of any number of tenants of a venue that may share access to a WWAN mobile core network through a shared WWAN/5G CPE device, such as WWAN gateway 104, in which data plane communications involving each of multiple tenants or, more specifically, any number of wireless devices served at each tenant location, can involve on-premise WLAN communications for the wireless devices, wired communications between the tenant WLAN AP and a shared, on-premise WWAN gateway, and WWAN (e.g., 5G) communications involving a single, shared WWAN PDU session.

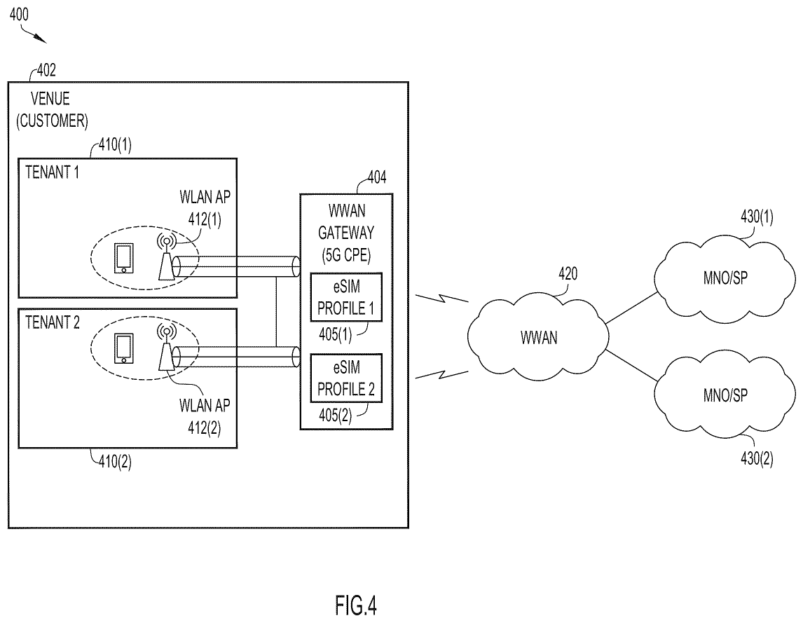

Referring to FIG. 4, FIG. 4 illustrates another system 400 in which WWAN equipment sharing may be provided for a multi-tenant environment, according to an example embodiment. In at least one embodiment, system 400 may include a venue 402, such as a LPV (e.g., a mall, office complex, etc.), a WWAN 420, and multiple mobile core networks, operated by different MNOs/SPs, such as a mobile core network 430(1) operated by a first MNO/SP, and a mobile core network 430(2) operated by a second MNO/SP in which the first MNO/SP is different than the second MNO/SP.

System 400 may be configured in a similar manner as system 100 of FIG. 1, such that a first tenant, Tenant1 410(1) may operate a WLAN involving a WLAN AP 412(1) that can serve any number of wireless devices present at the space/location of Tenant1 410(1), and a second tenant Tenant2 410(2) may operate a WLAN involving a WLAN AP 412(2) that can serve any number of wireless devices present at the space/location of Tenant2 410(2). Both of WLAN AP 412(1) and WLAN AP 412(2) can interface with a WWAN gateway 404 via corresponding wired connections and EoGRE tunnels.

However, for the embodiment of FIG. 4, WWAN gateway 404 can be configured with at least two WWAN/5G baseband processors or modems (not shown) and at least two eSIM profiles, such as an eSIM profile 405(1) and an eSIM profile 405(2) in which each eSIM profile 405(1) and 405(2) can be used to facilitate WWAN/5G connections with one of mobile core network 430(1) or mobile core network 430(2).

Thus, as shown in the embodiment of FIG. 4, in some instances a WWAN gateway, such as WWAN gateway 404, can facilitate connections with multiple, different mobile core networks operated by multiple, different MNOs/SPs.

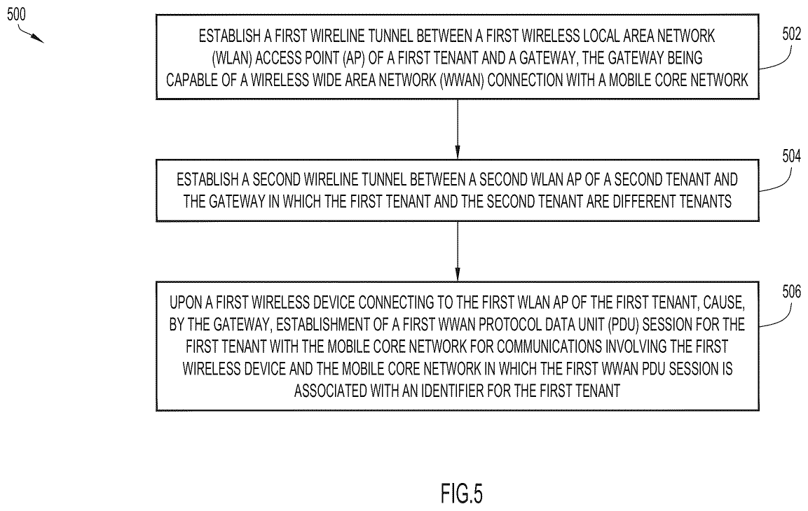

Referring to FIG. 5, FIG. 5 is a flow chart depicting a method 500 according to an example embodiment. In at least one embodiment, method 500 illustrates operations that may be performed by a shared WWAN gateway, such as WWAN gateway 104 and/or WWAN gateway 404, that can be shared among multiple tenants for a venue in order to facilitate WWAN connectivity to one or more mobile core networks.

At 502, the method may include establishing a first wireline tunnel between a first wireless local area network (WLAN) access point (AP) of a first tenant and a gateway (e.g., WWAN gateway 104/404), the gateway being capable of a wireless wide area network (WWAN) connection with a mobile core network.

At 504, the method may include establishing a second wireline tunnel between a second WLAN AP of a second tenant and the gateway in which the first tenant and the second tenant are different tenants.

At 506, the method may include upon a first wireless device connecting to the first WLAN AP of the first tenant, causing, by the gateway, establishment of a first WWAN protocol data unit (PDU) session for the first tenant with the mobile core network for communications involving the first wireless device and the mobile core network, wherein the first WWAN PDU session is associated with an identifier for the first tenant.

Although not shown in FIG. 5, in at least one embodiment, the method may further include, upon a second wireless device connecting to the second WLAN AP of the second tenant, causing, by the gateway, establishment of a second WWAN PDU session for the second tenant for communications involving the second wireless device in which the second WWAN PDU session is associated with a second identifier for the second tenant and the second WWAN PDU session is different than the first WWAN PDU session.

Although not shown in FIG. 5, in at least one embodiment, the method may include obtaining, by the gateway through establishment of the first WWAN PDU session, an IPV6 prefix, apportioning a first subset of IP addresses for the IPV6 prefix to the first tenant; upon a second wireless device connecting to the second WLAN AP of the second tenant, causing, by the gateway, apportioning a second subset of IP addresses for the IPV6 prefix to the second tenant; facilitating first data plane communications involving the first wireless device for the first WWAN PDU session in which the first wireless device is associated with a first IP address of the first subset of IP addresses, facilitating second data plane communications involving the second wireless device for the first WWAN PDU session in which the second wireless device is associated with a second IP address of the second subset of IP addresses (e.g., as shown/described at least for FIGS. 3A-3C).

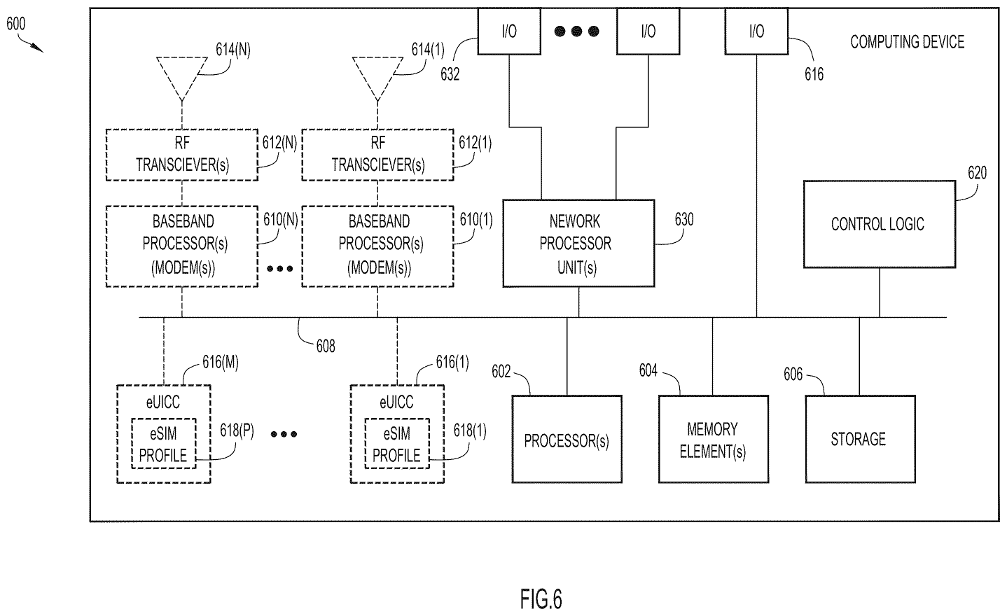

Referring to FIG. 6, FIG. 6 illustrates a hardware block diagram of a computing device 600 that may perform functions associated with operations discussed herein in connection with the techniques described for embodiments herein. In various embodiments, a computing device or apparatus, such as computing device 600 or any combination of computing devices 600, may be configured as any entity/entities in order to perform operations of the various techniques discussed for embodiments herein, such as any elements, functions, etc. discussed for embodiments herein (e.g., WWAN gateway 104, WWAN gateway 404, WLAN AP 112(1)/412(2), WLAN AP 112(2)/412(2), wireless device 114(1), wireless device 114(2), AMF 142, SMF 144, PCF 146, UDM 148, auth portal 150, AAA 154, AF 152, UPF 132, etc.).

In at least one embodiment, the computing device 600 may be any apparatus that may include one or more processor(s) 602, one or more memory element(s) 604, storage 606, a bus 608, one or more network processor unit(s) 630 interconnected with one or more network input/output (I/O) interface(s) 632, one or more I/O interface(s) 616, and control logic 620. In various embodiments, instructions associated with logic for computing device 600 can overlap in any manner and are not limited to the specific allocation of instructions and/or operations described herein.

For embodiments in which computing device 600 may be implemented as any device capable of wireless communications, such as WWAN and/or WLAN communications, computing device 600 may further include any ‘N’ number of baseband processors or modems 610(1)-610(N), radio RF transceiver(s) 612(1)-612(N) (e.g., any combination of RF receiver(s) and RF transmitter(s)), and antenna(s) or antenna array(s) 614(1)-614(N). Further for embodiments in which computing device 600 may be implemented as any device capable of wireless communications, such as WWAN communications (e.g., WWAN gateway 104/404), may be configured with any ‘M’ number of eUICC(s) 616(1)-616(M) and any ‘P’ number of eSIM profile(s) 618(1)-618(P). In some embodiments, multiple eSIM profiles can be configured for each of the one or more eUICC(s) 616(1)-616(M).

In at least one embodiment, processor(s) 602 is/are at least one hardware processor configured to execute various tasks, operations and/or functions for computing device 600 as described herein according to software and/or instructions configured for computing device 600. Processor(s) 602 (e.g., a hardware processor) can execute any type of instructions associated with data to achieve the operations detailed herein. In one example, processor(s) 602 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term ‘processor’.

In at least one embodiment, memory element(s) 604 and/or storage 606 is/are configured to store data, information, software, and/or instructions associated with computing device 600, and/or logic configured for memory element(s) 604 and/or storage 606. For example, any logic described herein (e.g., control logic 620) can, in various embodiments, be stored for computing device 600 using any combination of memory element(s) 604 and/or storage 606. Note that in some embodiments, storage 606 can be consolidated with memory element(s) 604 (or vice versa) or can overlap/exist in any other suitable manner.

In at least one embodiment, bus 608 can be configured as an interface that enables one or more elements of computing device 600 to communicate in order to exchange information and/or data. Bus 608 can be implemented with any architecture designed for passing control, data and/or information between processors, memory elements/storage, peripheral devices, and/or any other hardware and/or software components that may be configured for computing device 600. In at least one embodiment, bus 608 may be implemented as a fast kernel-hosted interconnect, potentially using shared memory between processes (e.g., logic), which can enable efficient communication paths between the processes.

In various embodiments, network processor unit(s) 630 may enable communication between computing device 600 and other systems, entities, etc., via network I/O interface(s) 632 (wired and/or wireless) to facilitate operations discussed for various embodiments described herein. In various embodiments, network processor unit(s) 630 can be configured as a combination of hardware and/or software, such as one or more Ethernet driver(s) and/or controller(s) or interface cards, Fibre Channel (e.g., optical) driver(s) and/or controller(s), wireless receivers/transmitters/transceivers, baseband processor(s)/modem(s), and/or other similar network interface driver(s) and/or controller(s) now known or hereafter developed to enable communications between computing device 600 and other systems, entities, etc. to facilitate operations for various embodiments described herein. In various embodiments, network I/O interface(s) 632 can be configured as one or more Ethernet port(s), Fibre Channel ports, any other I/O port(s), and/or antenna(s)/antenna array(s) now known or hereafter developed. Thus, the network processor unit(s) 630 and/or network I/O interface(s) 632 may include suitable interfaces for receiving, transmitting, and/or otherwise communicating data and/or information (wired and/or wirelessly) in a network environment.

I/O interface(s) 616 allow for input and output of data and/or information with other entities that may be connected to computing device 600. For example, I/O interface(s) 616 may provide a connection to external devices such as a keyboard, keypad, a touch screen, and/or any other suitable input and/or output device now known or hereafter developed. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor, a display screen, or the like.

For embodiments in which computing device 600 is implemented as a wireless device or any apparatus capable of wireless communications, the RF transceiver(s) 612(1)-612(N) may perform RF transmission and RF reception of wireless signals via antenna(s)/antenna array(s) 614(1)-614(N), and the baseband processor(s) or modem(s) 610(1)-610(N) perform baseband modulation and demodulation, etc. associated with such signals to enable wireless communications for computing device 600.

In various embodiments, control logic 620 can include instructions that, when executed, cause processor(s) 602 to perform operations, which can include, but not be limited to, providing overall control operations of computing device; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

The programs described herein (e.g., control logic 620) may be identified based upon application(s) for which they are implemented in a specific embodiment. However, it should be appreciated that any particular program nomenclature herein is used merely for convenience; thus, embodiments herein should not be limited to use(s) solely described in any specific application(s) identified and/or implied by such nomenclature.

In various embodiments, any entity or apparatus as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more entities as discussed herein could be provided in any database, table, register, list, cache, storage, and/or storage structure: all of which can be referenced at any suitable timeframe. Any such storage options may also be included within the broad term ‘memory element’ as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, memory element(s) 604 and/or storage 606 can store data, software, code, instructions (e.g., processor instructions), logic, parameters, combinations thereof, and/or the like used for operations described herein. This includes memory element(s) 604 and/or storage 606 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

In one form, a computer-implemented method is provided that may facilitate on-premise wireless wide area access network equipment sharing in a multi-tenant environment. In one form, a computer-implemented method is provided that may include establishing a first wireline tunnel between a first wireless local area network (WLAN) access point (AP) of a first tenant and a gateway, the gateway being capable of a wireless wide area network (WWAN) connection with a mobile core network; establishing a second wireline tunnel between a second WLAN AP of a second tenant and the gateway, wherein the first tenant and the second tenant are different tenants; and upon a first wireless device connecting to the first WLAN AP of the first tenant, causing, by the gateway, establishment of a first WWAN protocol data unit (PDU) session for the first tenant with the mobile core network for communications involving the first wireless device and the mobile core network, wherein the first WWAN PDU session is associated with an identifier for the first tenant.

In one instance, the method may include, upon a second wireless device connecting to the second WLAN AP of the second tenant, causing, by the gateway, establishment of a second WWAN PDU session for the second tenant for communications involving the second wireless device, wherein the second WWAN PDU session is associated with a second identifier for the second tenant.

In one instance, the mobile core network is a first mobile core network operated by a first mobile network provider and the second WWAN PDU session is established with a second mobile core network operated by a second mobile network provider.

In one instance, the first WWAN PDU session and the second WWAN PDU session are established at a user plane function (UPF) of the mobile core network and the identifier for the first tenant is included in charging information for the first WWAN PDU session and the second identifier for the second tenant is included in charging information for the second WWAN PDU session.

In one instance, the method may further include providing a redirect rule for the first WWAN PDU session at the UPF; upon obtaining, by the UPF, a first data packet involving a data plane communication for the first wireless device via the first WWAN PDU session, initiating, based on the redirect rule, authentication of the first tenant for the first WWAN PDU session via an internet web portal; and removing the redirect rule for the first WWAN PDU session upon successful authentication of the first tenant.

In one instance, the method may further include providing a redirect rule for the second WWAN PDU session at the UPF; upon obtaining, by the UPF, a first data packet involving a data plane communication for the second wireless device via the second WWAN PDU session, initiating, based on the redirect rule, authentication of the second tenant for the second WWAN PDU session via an internet web portal; and removing the redirect rule for the second WWAN PDU session upon successful authentication of the second tenant.

In one instance, the method may further include obtaining, by the gateway, a first Internet Protocol version 6 (IPv6) prefix for the first WWAN PDU session for the first tenant and a second IPv6 prefix for the second WWAN PDU session for the second tenant.

In one instance, the method may further include maintaining, by the gateway, a mapping between the first wireline tunnel or the first IPv6 prefix and the first WWAN PDU session for the first tenant; and maintaining, by the gateway, a mapping between the second wireline tunnel or the second IPv6 prefix and the second WWAN PDU session for the second tenant.

In one instance, the method may further include at least one of: providing, by the gateway, the identifier for the first tenant in a General Packet Radio Service (GPRS) Tunneling Protocol (GTP) header for data plane communications involving the first wireless device and the mobile core network for the first WWAN PDU session; or providing, by the gateway, the second identifier for the second tenant in a General Packet Radio Service (GPRS) Tunneling Protocol (GTP) header for data plane communications involving and the mobile core network for the second WWAN PDU session.

In one instance, the method may further include obtaining, by the gateway through establishment of the first WWAN PDU session, an Internet Protocol version 6 (IPv6) prefix; apportioning a first subset of IP addresses for the IPV6 prefix to the first tenant; upon a second wireless device connecting to the second WLAN AP of the second tenant, causing, by the gateway, apportioning a second subset of IP addresses for the IPV6 prefix to the second tenant; facilitating first data plane communications involving the first wireless device for the first WWAN PDU session, wherein the first wireless device is associated with a first IP address of the first subset of IP addresses; and facilitating second data plane communications involving the second wireless device for the first WWAN PDU session, wherein the second wireless device is associated with a second IP address of the second subset of IP addresses.

In one instance, the first wireline tunnel is a first Ethernet over General Routing Encapsulation (EoGRE) tunnel via a first wired connection with the gateway and the second wireline tunnel is a second EoGRE tunnel via a second wired connection with the gateway.

Thus, in accordance with some embodiments herein, for an initial packet involving a wireless device connecting to a given AP at a given tenant location, a dedicated PDU session can be created for the tenant via operations initiated via a WWAN gateway in which the dedicated PDU session can mapped to the ingress EoGRE tunnel by the WWAN gateway. In accordance with some embodiments, a shared PDU session can facilitate communications for multiple tenants via a shared WWAN gateway.

Service activation for utilizing a WWAN gateway by the tenant can be based on the tenant's successful Web-Registration, with a UPF hosting the PDU session for the tenant applying HTTP-Redirect rules for web authentication and charging identity (ID) generation.

Accordingly, embodiments herein provide for the ability to support 5G connectivity/services for multiple tenants behind a shared 5G on-premise device having a wired connection with WLAN APs provided for each of multiple tenants, such as shared WWAN gateway 104/404. Embodiments herein further provide for the ability to dynamically on-board/authenticate devices behind the on-premise device (e.g., on the wired side of the device), with a distinct charging ID and a tenant specific service offering provided on a per-tenant basis to the multiple tenants sharing the on-premise device.

In some instances, embodiments herein may facilitate allocating a unique prefix for each PDU session and managing IP allocations from that prefix for all the tenant (wireless) devices for a particular tenant behind a WLAN access point that interfaces with the shared 5G on-premise device. In some instances, embodiments herein may enable HTTP redirect rules being configured for a UPF based on any of a line-identity, access point/WLC, and/or tenant device basis. Embodiments herein may also facilitate applying a secondary authentication process, such as WebAuth, on a PDU session/tenant basis. Embodiments herein may further facilitate mapping an ingress access point/WLC (tenant gateway) to a unique PDU session by a shared 5G on-premise device, such as shared WWAN gateway 104/404.

### Variations and Implementations

Generally, per-3GPP standards for a mobile core network, an AMF interfaces with a SMF which can further interface with one or more UPFs. An AMF and an SMF can further interface with PCF, a UDM/UDR, and various other core network functions via 3GPP Service-Based Interface (SBI) constructs/interfaces and/or any other 3GPP interfaces/reference points. An AMF and a UPF can further interface with a RAN node, such as one or more gNBs or disaggregated components thereof.

One or more wireless device sessions, often referred to as PDU sessions can be established between a wireless device and a UPF for a core network in which the session may be facilitated/managed by an SMF, as is generally understood in the art.

Generally, a radio access may include one or more radio access network (RAN) radio nodes that may implement a wireless wide area (WWA) (e.g., cellular) air interface and, in some instances also a wireless local area (WLA) (e.g., Wi-Fi®) air interface, for any combination of Radio Access Technology (RAT) types (e.g., ‘accesses’), such as 3GPP WWA licensed spectrum accesses (e.g., Fourth Generation/Long Term Evolution (4G/LTE), 5G/New Radio (NR) accesses); 3GPP unlicensed spectrum accesses (e.g., Licensed-Assisted Access (LAA), enhanced LAA (eLAA), further enhanced LAA (fcLAA), and New Radio Unlicensed (NR-U)); non-3GPP licensed/unlicensed spectrum wireless local area (WLA) accesses such as Institute of Electrical and Electronics Engineers (IEEE) 802.11 (e.g., Wi-Fi®); IEEE 802.16 (e.g., WiMAX®), Near Field Communications (NFC), Bluetooth®, and/or the like; Citizens Broadband Radio Service (CBRS) accesses; combinations thereof; and/or the like.

Thus, a WWAN RAN radio node may be inclusive of any configuration/combination of 3GPP 4G/LTE evolved Node Bs (eNBs or eNodeBs), 5G next Generation Node Bs (gNBs or gNodeBs), and/or any other next Generation access nodes that may include hardware and/or software to perform baseband signal processing (such as modulation/demodulation) as well as hardware (e.g., baseband processors (modems), transmitters and receivers, transceivers, and/or the like)), software, logic and/or the like to facilitate signal transmissions and signal receptions via antenna assemblies (not shown) in order to provide over-the-air Radio Frequency (RF) coverage for one or more access types (e.g., 4G/LTE, 5G, nG, CBRS, etc.) through which one or more wireless devices (e.g., WWAN gateway 104/404), may utilize to connect for one or more sessions (e.g., voice/IMS, data/internet (e.g., video, gaming, etc.), combinations thereof, etc.).

A wireless device, such as any of wireless device 114(1)/114(2), WWAN gateway 104/404, or any other wireless devices discussed herein, may be considered any electronic device, etc. that initiates a connection or communication session with a corresponding core network, and may be inclusive of but not limited to a computer, a mobile phone or mobile communication device, an electronic tablet, a laptop, etc., an electronic device such as an industrial device (e.g., a robot), automation device, enterprise device, appliance, Internet of Things (IoT) device, a router or gateway with a WWA/WLA interface (e.g., WWAN gateway 104/404), a WWA/WLA (cellular/Wi-Fi®) enabled device, and/or any other device, component, element, or object capable of initiating voice, audio, video, media, or data exchanges within a system. Thus, a wireless device may include any hardware and/or software to perform baseband signal processing (such as modulation/demodulation) as well as hardware (e.g., baseband processors (modems), transmitters and receivers, transceivers, and/or the like), software, logic and/or the like to facilitate signal transmissions and signal receptions via antenna assemblies (not shown) in order to connect to one or more radio nodes of one or more RAN(s).

Generally, an AMF may facilitate access and mobility management control/services for one or more wireless devices seeking connection to/connected to a mobile core network. Generally, an SMF may be responsible for wireless device session management, with individual functions/services being supported on a per-session basis in order to facilitate data transfer(s) between a wireless device and one or more networks via one or more UPFs. Generally, a UPF may operate to provide packet routing and forwarding operations for user data traffic and may also perform a variety of functions such as packet inspection, traffic optimization, Quality of Service (QoS), policy enforcement and user data traffic handling (e.g., to/from one or more data networks), billing operations (e.g., accounting, etc.), among other operations, for wireless device sessions. Typically, a UDM stores subscription data (typically in combination with a UDR) for subscribers (e.g., a user that may be associated with a given wireless device) that can be retrieved and/or otherwise obtained/utilized during operation of a core network system. Typically, a PCF stores policy data in order to provide policy control services (e.g., to facilitate access control for one or more UEs, such as WWAN gateway 104/404, network selection, etc.). Typically, a charging function (CHF) provides support for charging services such as facilitating the transfer of policy counter information associated with subscriber (e.g., UE) spending limits, etc.

In general, authentication services may include authenticating and/or authorizing one or more device(s) for one or more connections and/or communications and may be inclusive of any Authentication, Authorization, and Accounting (AAA) services that may be facilitated via any combination of authentication/authorization protocols such as Remote Authentication Dial-In User Service (RADIUS), DIAMETER, Extensible Authentication Protocol (EAP) [including any EAP variations], and/or the like. Generally, authentication refers to a process in which an entity's identity is authenticated, typically by providing evidence that it holds a specific digital identity such as an identifier/identity and corresponding credentials/authentication attributes/etc. Generally, authorization can be used to determine whether a particular entity is authorized to perform a given activity.

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 802.11 (e.g., Wi-Fi®/Wi-Fi6®), IEEE 802.16 (e.g., Worldwide Interoperability for Microwave Access (WiMAX)), Radio-Frequency Identification (RFID), Near Field Communication (NFC), Bluetooth™, mm.wave, Ultra-Wideband (UWB), etc.), and/or wired communications (e.g., TI lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may directly or indirectly connected utilizing any algorithms, communication protocols, interfaces, etc. (proprietary and/or non-proprietary) that allow for the exchange of data and/or information.

In various example implementations, any entity or apparatus for various embodiments described herein can encompass network elements (which can include virtualized network elements, functions, etc.) such as, for example, network appliances, forwarders, routers, servers, switches, gateways, bridges, loadbalancers, firewalls, processors, modules, radio receivers/transmitters, or any other suitable device, component, element, or object operable to exchange information that facilitates or otherwise helps to facilitate various operations in a network environment as described for various embodiments herein. Note that with the examples provided herein, interaction may be described in terms of one, two, three, or four entities. However, this has been done for purposes of clarity, simplicity and example only. The examples provided should not limit the scope or inhibit the broad teachings of systems, networks, etc. described herein as potentially applied to a myriad of other architectures.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein and in the claims, the term ‘packet’ may be used in a generic sense to include packets, frames, segments, datagrams, and/or any other generic units that may be used to transmit communications in a network environment. Generally, a packet is a formatted unit of data that can contain control or routing information (e.g., source and destination address, source and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. Internet Protocol (IP) addresses discussed herein and in the claims can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of,’ ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Each example embodiment disclosed herein has been included to present one or more different features. However, all disclosed example embodiments are designed to work together as part of a single larger system or method. This disclosure explicitly envisions compound embodiments that combine multiple previously discussed features in different example embodiments into a single system or method.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of can be represented using the’ (s)′ nomenclature (e.g., one or more element(s)).

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

What is claimed is:

1. A method comprising:
establishing a first wireline tunnel between a first wireless local area network (WLAN) access point (AP) of a first tenant and a gateway, the gateway being capable of a wireless wide area network (WWAN) connection with a mobile core network;
establishing a second wireline tunnel between a second WLAN AP of a second tenant and the gateway, wherein the first tenant and the second tenant are different tenants; and
upon a first wireless device connecting to the first WLAN AP of the first tenant, causing, by the gateway, establishment of a first WWAN protocol data unit (PDU) session for the first tenant with the mobile core network for communications involving the first wireless device and the mobile core network, wherein the first WWAN PDU session is associated with an identifier for the first tenant.

2. The method of claim 1, further comprising:
upon a second wireless device connecting to the second WLAN AP of the second tenant, causing, by the gateway, establishment of a second WWAN PDU session for the second tenant for communications involving the second wireless device, wherein the second WWAN PDU session is associated with a second identifier for the second tenant.

3. The method of claim 2, wherein the mobile core network is a first mobile core network operated by a first mobile network provider and the second WWAN PDU session is established with a second mobile core network operated by a second mobile network provider.

4. The method of claim 2, wherein the first WWAN PDU session and the second WWAN PDU session are established at a user plane function (UPF) of the mobile core network and the identifier for the first tenant is included in charging information for the first WWAN PDU session and the second identifier for the second tenant is included in charging information for the second WWAN PDU session.

5. The method of claim 4, further comprising:
providing a redirect rule for the first WWAN PDU session at the UPF;
upon obtaining, by the UPF, a first data packet involving a data plane communication for the first wireless device via the first WWAN PDU session, initiating, based on the redirect rule, authentication of the first tenant for the first WWAN PDU session via an internet web portal; and
removing the redirect rule for the first WWAN PDU session upon successful authentication of the first tenant.

6. The method of claim 4, further comprising:
providing a redirect rule for the second WWAN PDU session at the UPF;
upon obtaining, by the UPF, a first data packet involving a data plane communication for the second wireless device via the second WWAN PDU session, initiating, based on the redirect rule, authentication of the second tenant for the second WWAN PDU session via an internet web portal; and
removing the redirect rule for the second WWAN PDU session upon successful authentication of the second tenant.

7. The method of claim 2, further comprising:
obtaining, by the gateway, a first Internet Protocol version 6 (IPv6) prefix for the first WWAN PDU session for the first tenant and a second IPv6 prefix for the second WWAN PDU session for the second tenant.

8. The method of claim 7, further comprising:
maintaining, by the gateway, a mapping between the first wireline tunnel or the first IPV6 prefix and the first WWAN PDU session for the first tenant; and
maintaining, by the gateway, a mapping between the second wireline tunnel or the second IPv6 prefix and the second WWAN PDU session for the second tenant.

9. The method of claim 8, further comprising at least one of:
providing, by the gateway, the identifier for the first tenant in a General Packet Radio Service (GPRS) Tunneling Protocol (GTP) header for data plane communications involving the first wireless device and the mobile core network for the first WWAN PDU session; or
providing, by the gateway, the second identifier for the second tenant in a General Packet Radio Service (GPRS) Tunneling Protocol (GTP) header for data plane communications involving and the mobile core network for the second WWAN PDU session.

10. The method of claim 1, further comprising:
obtaining, by the gateway through establishment of the first WWAN PDU session, an Internet Protocol version 6 (IPv6) prefix;
apportioning a first subset of IP addresses for the IPv6 prefix to the first tenant;
upon a second wireless device connecting to the second WLAN AP of the second tenant, causing, by the gateway, apportioning a second subset of IP addresses for the IPV6 prefix to the second tenant;
facilitating first data plane communications involving the first wireless device for the first WWAN PDU session, wherein the first wireless device is associated with a first IP address of the first subset of IP addresses; and
facilitating second data plane communications involving the second wireless device for the first WWAN PDU session, wherein the second wireless device is associated with a second IP address of the second subset of IP addresses.

11. The method of claim 1, wherein the first wireline tunnel is a first Ethernet over General Routing Encapsulation (EoGRE) tunnel via a first wired connection with the gateway and the second wireline tunnel is a second EoGRE tunnel via a second wired connection with the gateway.

12. One or more non-transitory computer readable storage media encoded with instructions that, when executed by a processor, cause the processor to perform operations, comprising
establishing a first wireline tunnel between a first wireless local area network (WLAN) access point (AP) of a first tenant and a gateway, the gateway being capable of a wireless wide area network (WWAN) connection with a mobile core network;
establishing a second wireline tunnel between a second WLAN AP of a second tenant and the gateway, wherein the first tenant and the second tenant are different tenants; and
upon a first wireless device connecting to the first WLAN AP of the first tenant, causing, by the gateway, establishment of a first WWAN protocol data unit (PDU) session for the first tenant with the mobile core network for communications involving the first wireless device and the mobile core network, wherein the first WWAN PDU session is associated with an identifier for the first tenant.

13. The media of claim 12, wherein the instructions, when executed by the processor, cause the processor to perform further operations, comprising:
upon a second wireless device connecting to the second WLAN AP of the second tenant, causing, by the gateway, establishment of a second WWAN PDU session for the second tenant for communications involving the second wireless device, wherein the second WWAN PDU session is associated with a second identifier for the second tenant.

14. The media of claim 13, wherein the mobile core network is a first mobile core network operated by a first mobile network provider and the second WWAN PDU session is established with a second mobile core network operated by a second mobile network provider.

15. The media of claim 13, wherein the first WWAN PDU session and the second WWAN PDU session are established at a user plane function (UPF) of the mobile core network and the identifier for the first tenant is included in charging information for the first WWAN PDU session and the second identifier for the second tenant is included in charging information for the second WWAN PDU session.

16. A system comprising:
at least one memory element for storing data; and
at least one processor for executing instructions associated with the data, wherein executing the instructions causes the system to perform operations, comprising:
establishing a first wireline tunnel between a first wireless local area network (WLAN) access point (AP) of a first tenant and a gateway, the gateway being capable of a wireless wide area network (WWAN) connection with a mobile core network;
establishing a second wireline tunnel between a second WLAN AP of a second tenant and the gateway, wherein the first tenant and the second tenant are different tenants; and
upon a first wireless device connecting to the first WLAN AP of the first tenant, causing, by the gateway, establishment of a first WWAN protocol data unit (PDU) session for the first tenant with the mobile core network for communications involving the first wireless device and the mobile core network, wherein the first WWAN PDU session is associated with an identifier for the first tenant.

17. The system of claim 16, wherein executing the instructions causes the system to perform further operations, comprising:
upon a second wireless device connecting to the second WLAN AP of the second tenant, causing, by the gateway, establishment of a second WWAN PDU session for the second tenant for communications involving the second wireless device, wherein the second WWAN PDU session is associated with a second identifier for the second tenant.

18. The system of claim 17, wherein the mobile core network is a first mobile core network operated by a first mobile network provider and the second WWAN PDU session is established with a second mobile core network operated by a second mobile network provider.

19. The system of claim 17, wherein the first WWAN PDU session and the second WWAN PDU session are established at a user plane function (UPF) of the mobile core network and the identifier for the first tenant is included in charging information for the first WWAN PDU session and the second identifier for the second tenant is included in charging information for the second WWAN PDU session.

20. The system of claim 19, wherein executing the instructions causes the system to perform further operations, comprising:
providing a redirect rule for the first WWAN PDU session at the UPF;
upon obtaining, by the UPF, a first data packet involving a data plane communication for the first wireless device via the first WWAN PDU session, initiating, based on the redirect rule, authentication of the first tenant for the first WWAN PDU session via an internet web portal; and
removing the redirect rule for the first WWAN PDU session upon successful authentication of the first tenant.
